(19) United States
(12) Patent Application Publication
(10) Pub. No.: US 2010/0235008 A1
(43) Pub. Date: Sep. 16, 2010

(54) SYSTEM AND METHOD FOR DETERMINING CARBON CREDITS UTILIZING TWO-WAY DEVICES THAT REPORT POWER USAGE DATA

(76) Inventors: Joseph W. Forbes, JR., Wake Forest, NC (US); Joel L. Webb, Raleigh, NC (US)

Correspondence Address: GRAY ROBINSON, P.A., P.O. Box 2328, FT. LAUDERDALE, FL, 33303-9998, US

(21) Appl. No.: 12/783,415

(22) Filed: May 19, 2010

Related U.S. Application Data
(63) Continuation-in-part of application No. 12/715,124, filed on Mar. 1, 2010.
Application No. 12/715,124 is a division of application No. 11/895,909, filed on Aug. 28, 2007, now Pat. No. 7,715,951.
Application No. 11/895,909 is a continuation-in-part of application No. 12/001,819, filed on Dec. 13, 2007.
(60) Provisional application No. 61/216,712, filed on May 20, 2009.

(51) Int. Cl. G05D 7/00; G06F 1/26

(52) U.S. Cl. 700/291; 700/22; 700/297; 700/286

(57) ABSTRACT

A load management system controller employs a method for determining carbon credits earned as a result of a control event in which power is reduced to at least one service point serviced by a utility. The controller is located remotely from the service point(s) and determines power consumed over time by at least one device located at the service point(s) to produce power consumption data. The controller stores the power consumption data. At some later point in time, the controller initiates a control event and determines an amount of power reduced during the control event based on the stored power consumption data. The controller also determines a generation mix for power that would have been supplied to the service point(s) if the control event had not occurred. The controller then determines a quantity of carbon credits earned based at least on the amount of power reduced and the generation mix.

### CROSS REFERENCE TO RELATED APPLICATIONS

This application is a continuation-in-part of co-pending U.S. application Ser. No. 12/715,124 filed on Mar. 1, 2010, which is a division of U.S. application Ser. No. 11/895,909 filed on Aug. 28, 2007, now U.S. Pat. No. 7,715,951, and is incorporated herein by this reference as if fully set forth herein. This application is also a continuation-in-part of co-pending U.S. application Ser. No. 12/001,819 filed on Dec. 13, 2007, which application is incorporated herein by this reference as if fully set forth herein. This application further claims priority under 35 U.S.C. §119(e) upon U.S. Provisional Application Ser. No. 61/216,712 filed on May 20, 2009 solely to the extent of the subject matter disclosed in said provisional application, which application is incorporated herein by this reference as if fully set forth herein. Finally, this application is related to U.S. application Ser. No. 12/775,979, which is entitled “System and Method for Estimating and Providing Dispatchable Operating Reserve Energy Capacity Through Use of Active Load Management,” was filed on May 7, 2010, and is incorporated herein by this reference as if fully set forth herein.

### BACKGROUND OF THE INVENTION

1. Field of the Invention

The present invention relates generally to electric power supply and generation systems and, more particularly, to an apparatus and method for determining measurable, reportable, and verifiable carbon credits using a two-way measuring and reporting system.

2. Description of Related Art

The increased awareness of the impact of carbon emissions from the use of fossil-fueled electric generation combined with the increased cost of producing peak power during high load conditions has increased the need for alternative solutions utilizing load control as a mechanism to reduce, or in some cases eliminate, the need for the deployment of additional generation capacity by electric utilities. Existing electric utilities are pressed for methods to reduce, defer or eliminate the need for construction of fossil-fuel based electricity generation. Today, a patchwork of systems exist to implement demand response load management programs (e.g., typically referred to as demand side management (DSM)), whereby various radio subsystems in various frequency bands utilize “one-way” transmit only methods of communication. Under these programs, radio frequency (RF) controlled relay switches are typically attached to a customer's air conditioner, water heater, or pool pump. A blanket command is sent out to a specific geographic area whereby all receiving units within the range of the transmitting station (e.g., typically a paging network) are turned off for short periods of time during peak hours at the election of the power utility. After a predetermined period of time or a period of time when the peak load has passed, a second blanket command is sent to turn on those devices that have been turned off. The customer subscribing to the DSM program receives a discount for allowing the serving electrical supplier (utility) to connect to their electrical appliances and deactivate those appliances temporarily during high energy usage periods.

Independent of DSM, tele-metering has been used for the express purpose of reporting energy usage. However, no techniques currently exist for calculating power consumption and/or greenhouse gas emissions (e.g., carbon gas emissions, sulfur dioxide (SO₂) gas emissions, and/or nitrogen dioxide (NO₂) gas emissions) and reporting the state of a particular power consuming device or set of power consuming devices operating under the control of a two-way positive control load management policy. As discussed above, one way wireless communications devices have been utilized independently in DSM systems to de-activate electrical appliances, such as heating, ventilation, and air-conditioning (HVAC) units, water heaters, pool pumps, and lighting, from an existing electrical supplier or distribution partner's network during peak load periods. Additionally, the one-way devices are typically connected to a serving electrical supplier's control center via landline trunks, or in some cases, microwave transmission to a paging transmitter.

Many electric utilities, including power generating utilities and serving utilities (such as electric cooperatives and municipalities that enter into power supply agreements with power-generating entities), are driven by the economic realities associated with the increasing costs of producing electricity using carbon-based fuels (e.g., coal, oil, and natural gas) coupled with the potential damage to the environment resulting from the use of such fuels. Even with those realities, most of the focus in the electric utility industry for reducing or eliminating dependence upon carbon-based fuels or reducing the effect carbon-based fuels have on the environment is in two areas, namely, clean coal technologies and peak load shedding through traditional well understood methods. Such load-shedding methods employed by the electric utility industry generally include: (a) time of use programs and rates to encourage customers to defer or reduce power consumption during peak times by either manually or electronically (e.g., through use of commercially available timers or programmable thermostats) turning off power consuming devices, such as lights, pool pumps, and HVAC systems; (b) efficiency programs that encourage improving insulation and/or the use of more electrically efficient appliances and light bulbs; (c) peak generation construction through which power generation companies produce power only during periods of very high peak loads (e.g., less than 10% of total load times); (d) automated load shedding programs, such as DSM, that use one way load control techniques; and (e) voluntary efficiency programs where companies or industries agree to have their supply cut or reduced for better wholesale electricity prices. Many of these techniques have primarily been utilized for industrial customers who have higher base electrical consumption than do residential and small/medium business customers.

Due to the prominence of the aforementioned legacy peak load and base load abatement techniques, most of the prior art in the load shedding and peak power generation fields revolves around improving or creating new methods based on the aforementioned ideas. One exemplary method of generating excess demand-related electricity is described in U.S. Patent Application Publication No. US 2003/0144864 A1 to Mazzarella. This publication discloses a method whereby individual power generating entities are envisioned operating a distributed power generation system comprising one or more local production units. The local production units are controlled by a central controller and brought on-line in the event of a peak load demand in excess of supply. This patent publication describes co-generation by various means including gas fired and diesel generation.

In addition to the present economics of electric power production and distribution, there is currently some concern about the gaseous emissions that result from the use of carbon-based fuels to generate electricity and the effect of such emissions on the world's climate. As a result, some environmentalists are presently urging electric utilities and others to investigate and develop alternative sources for generating power. To address environmental concerns, so-called “carbon credits” have been created on an international scale to provide a basis for cities, states, countries, businesses, and even individuals to gauge their use of carbon-based fuels and control their associated emissions. An international framework for computing carbon credits is set forth in the Kyoto Protocol. According to the Kyoto Protocol and other international convention, a carbon credit corresponds to one (1) metric ton (or 1000 kilograms) of carbon dioxide or carbon dioxide equivalents that is either emitted into the atmosphere (in which case, the carbon credit is considered used) or withheld from the atmosphere (in which case, the carbon credit is considered earned). For example, a typical car emits 5400 kilograms or 5.4 metric tons of carbon dioxide in a year. Thus, use of a car for a year corresponds to using 5.4 carbon credits. Carbon dioxide equivalents are quantities that relate the warming potential caused by the emission of greenhouse gases other than carbon dioxide over a period of time (e.g., 100 years) to the warming potential caused by carbon dioxide emissions over the same time period.

Under the Kyoto Protocol and according to international carbon credit markets, a carbon credit has a specific value. So, if a carbon credit is worth, for example, $10, then 5.4 carbon credits would be worth $54. Carbon credits may be traded among carbon-based fuel users in an attempt to maintain a global or local maximum level of carbon fuel based emissions. Markets have developed for carbon credits and the trading of carbon credits on the open market has been the subject of various proposed methods.

For instance, one exemplary carbon credit trading method is disclosed in U.S. Patent Application Publication No. US 2002/0143693 A1 to van Soestbergen. This publication details a technique for trading carbon credits on an open market. The publication discloses an on-line trading network, whereby carbon credits can be bought and sold electronically, preferably though a bank. Another similar carbon credit trading method is disclosed in U.S. Patent Application Publication No. US 2005/0246190 A1 to Sandor et al.

Under the current state of the electric utility industry, power generating utilities have the ability to sell excess power not used by their customers or contract purchasers (e.g., electric cooperatives and municipalities) and trade their unused carbon credits. However, electric cooperatives and municipalities are not so fortunate because carbon credits associated with their energy usage or savings are credited to carbon footprints of the power generating entities supplying their power. Additionally, power saved by electric cooperatives and municipalities results in excess power available for sale by the power generating entities without any benefit to the electric cooperatives and municipalities.

Besides providing a framework for computing carbon credits, the Kyoto Protocol also provides a framework for reducing carbon emissions. Under the Kyoto Protocol, most industrialized countries are to reduce their greenhouse gas emissions by 5.2% from 1990 levels by the year 2012. A significant amount of the greenhouse gas emissions referenced in the Kyoto Protocol, such as carbon dioxide, methane, nitrous oxide, sulfur hexafluoride, and other greenhouse gases, are produced by power utilities. Under the Kyoto Protocol, one strategy for reducing greenhouse gas emissions is by reducing the emissions of power utilities.

Proposals for implementing the Kyoto Protocol were further outlined in the Bali Roadmap. Within this roadmap or action plan, developing nations are to consider taking “measurable, reportable, and verifiable” actions to mitigate greenhouse gases. Additionally, developed countries have been asked to develop technology that would allow actions taken to reduce greenhouse gases to be “measurable, reportable, and verifiable.”

The various fuels used by the power industry to generate electricity have varying rates at which they generate carbon dioxide and/or other greenhouse gases when they are consumed. The carbon dioxide or carbon dioxide equivalent generation rate is measured in pounds or kilograms per kilowatt-hour. For instance, the average coal-burning plant generates two (2) pounds of carbon dioxide for every kilowatt-hour of electricity generated. Typically, the amount of carbon dioxide or carbon dioxide equivalents produced is indicated in metric tons as discussed above.

For an individual generator, it is possible to calculate the amount of carbon dioxide or other greenhouse gases emitted by the generator based on the type of fuel used to produce the electricity. At any given point in time, a utility is generating carbon dioxide and/or other greenhouse gas emissions based on the number of generators in its generating capacity. A combination of different types of fuel is used at or by a utility's generators at any point in time, and that mixture of fuels and the amount of each type of fuel is known. The mixture of fuels used by the utility at a particular point in time is referred to as the utility's “generation mix.” Thus, a utility may calculate the number of pounds of carbon dioxide or other greenhouse gases emitted by the utility at any point in time based on knowing the utility's generation mix at that point in time and the carbon dioxide and/or other greenhouse gas generation rates for the fuels forming the particular generation mix. Once the total amount of carbon dioxide and/or other greenhouse gas emissions is known, the utility may determine the carbon dioxide and/or other greenhouse gas emissions associated with powering an individual service point (e.g., a residence or business) or one or more power consuming devices (e.g., HVAC unit, hot water heater, air purifier system, pool pump, etc.) at the service point, provided that the power supplied to the service point or devices therein is accurately or verifiably measured and reported. However, existing approaches to energy demand management or DSM, such as one-way load control, do not verifiably measure and report power consumed or saved and, therefore, provide no mechanism or procedure for reducing greenhouse gases, which is “measurable, reportable, and verifiable” as required under the Kyoto Protocol and Bali Roadmap.

Nowadays, some service points include their own power generation capabilities through use of solar panels, wind turbines, fuel cells, and other power generation devices. As a result, the United States enacted the Energy Policy Act of 2005 to require public utilities to provide so-called “net metering service” to customers that request it. Net metering service offsets the energy provided to a customer when that customer generates excess or net energy using their own facilities. Such facilities may include solar panels, wind turbines, or fuel cells. More particularly, net metering allows the owner of, or utility customer at, a service point to receive credit for energy produced by the owner or customer in excess of the power used by the customer from the customer's own generation source. This credit may be in various forms, including credit against energy consumed, discount rates, rebates, or other economic benefits.

Normally, the meters of utility customers run forward. However, when a customer has a power generating device and that customer's generator is producing more power than is being consumed, most states allow the customer's electric meter to run backward, generating credits. These net metering customers are charged only for the “net” power that they consume from the utility that has accumulated over a designated period of time, or, if their energy-generating systems make more electricity than is consumed, they may be credited or paid for the excess electricity contributed to the grid over that same time period. Net metering is made practical by using smart meters with two-way communication between the utility and the customer. Smart meters are commercially available from a variety of companies, such as General Electric Company, Elster Corporation, Itron Corporation, and Landis & Gyr.

Renewable energy credits represent an environmental improvement that generally parallels that of carbon credits. Renewable or replenishable energy is power provided through renewable generation sources, such as the sun, wind, rain, tides, geothermal heat, or other replenishable sources. In some states, power utilities are required to provide a percentage of their electricity through renewable energy. In other states, power utilities have a goal to produce a certain amount of the electricity from renewable generation sources, but there are no regulatory requirements to do so.

Renewable energy credits are tradable commodities, and each renewable energy credit certifies that one (1) Megawatt hour (MWh) of electricity was created from renewable energy sources. While carbon credits promote the reduction of carbon emissions during the production of electricity, renewable energy credits promote the use of renewable energy. Renewable energy credits face some of the same credibility issues as do carbon credits because the amount of electricity produced using renewable sources is not always easy to measure, report, or verify. Renewable energy credits are commonly referred to as “Renewable Energy Certificates” (RECs), “Green Tags,” and/or “Tradable Renewable Certificates.”

Dynamic load control as part of a DSM implementation may also be considered renewable energy because the energy “generated” through reductions in energy consumed by utility customers can be replenished within a short period of time. As discussed above, DSM is one method by which power utilities carry out actions, such as load control, to try to reduce demand during peak consumption periods. Current approaches for using DSM to respond to increases in demand have included using statistics to approximate the average amount of projected load removed by DSM. A statistical approach is employed because of the utility's inability to measure the actual load removed from the grid as a result of a DSM load control event. As a result, existing DSM approaches implementing one-way load control provide no mechanism or procedure for verifiably measuring the amount of load reduced at a micro-level, such as at a particular service point or for a group of service points served by the utility.

Therefore, a need exists for a method and apparatus to determine carbon credits and renewable energy credits which result from measurable, reportable, and verifiable load control activities.

### SUMMARY OF THE INVENTION

According to one embodiment, the present invention provides a method for determining carbon credits earned as a result of a control event in which power is reduced to at least one service point connected to a power grid serviced by one or more utilities. According to the method of this embodiment, power consumed by at least one device located at the service point or points is determined during at least one period of time to produce power consumption data. The power consumption data is then stored (e.g., in a database or other repository). At some later point in time, a control event is initiated during which power is reduced to one or more devices at the service points. The control event may be initiated in response to a command from a utility, stored customer personal settings, a separate request from a customer, or otherwise. An amount of power reduced during the control event is then determined based on the stored power consumption data. A generation mix is determined for power that would have been supplied to the devices during a time period of the control event if the control event had not occurred. A quantity of carbon credits earned is then determined based at least on the amount of power reduced and the generation mix. According to one preferred embodiment, the method is executed by a controller located remotely from the service points. In particular, the method may be executed by a processor of the controller.

According to an alternative embodiment, the generation mix includes a set of energy sources that have carbon footprints due to, for example, the emission of carbon dioxide and/or other greenhouse gases in connection therewith, such as during the generation of their respective energy, during the production of components used to generate their respective energy (e.g., photovoltaic cells for solar energy), and/or during the acquisition of fuel used to generate their respective energy (e.g., mining of uranium for nuclear energy). According to this embodiment, the quantity of carbon credits earned may be determined by determining an amount of carbon dioxide equivalents based on the amount of power reduced and a percentage of the generation mix formed by the set of energy sources, and determining the quantity of carbon credits based at least on the amount of carbon dioxide equivalents.

According to another embodiment, line loss between a utility power generating plant and a service area containing one or more of the service points, or between the power plant and the service points themselves, may be determined. The quantity of carbon credits earned may then be determined based at least on the amount of power reduced, the generation mix, and the line loss. Optionally, k-factors of the power grid's electrical transmission equipment may be taken into account in determining the line loss.

According to a further embodiment, a power storage device may be included at one or more of the service points. In such a case, an amount of power supplied to the power storage device during a first time period (e.g., from the power grid and/or from a local power generating device) may be determined. Additionally, a first generation mix relating to the amount of power supplied to the power storage device may be determined. Further, an amount of power dispatched to the power grid from the power storage device during a second time period may be determined. A second generation mix relating to power supplied by the power grid during the second time period to a service area in which the service point containing the power storage device is located may be determined. Net carbon credits earned with respect to dispatch of power from the power storage device may then be determined based on the amount of power supplied to the power storage device, the first generation mix, the second generation mix, and the amount of power dispatched to the power grid by the power storage device.

According to yet another embodiment in which a controller performs the carbon credits determination, the controller receives power consumption information for the power consuming devices from one or more clients devices located at the service points. The controller determines power consumed by the power consuming devices based on the received power consumption information and stores the determined power consumption data (e.g., in a database). Additionally, the controller in this embodiment may transmit a message to one or more client devices instructing the client devices to turn off power to one or more power consuming devices located at the service points. Further, the controller in this embodiment may receive an override request to terminate the control event with respect to one or more of the power consuming devices, which could include a request to terminate the control event with respect to all devices at a service point (i.e., an entire service point). The override request may be received through an Internet-based interface of the controller. Responsive to the override request, the controller may transmit a second message to the affected client device or devices, wherein the second message instructs the affected client devices to turn on power to the previously turned off power consuming devices. The controller may then determine the quantity of carbon credits associated with the service point taking into account the early termination of the control event.

According to a further embodiment, one or more of the power consuming devices at a service point requires start-up current upon initial power up. In such a case, the power consumption information provided by the client device for the service point includes information regarding the start-up current. Accordingly, the controller may determine the amount of power reduced during the control event taking into account the start-up current saved during the control event (e.g., when power is turned off during the control event to the device requiring start-up current).

According to another embodiment, power consuming devices at a service point have respective duty cycles. In such a case, the quantity of carbon credits earned may be determined based at least on the amount of power reduced to each device, the respective duty cycle of each device, and the generation mix. Additionally, each service point may have a respective duty cycle determined as a percentage of time that all devices located at the service point are consuming power during a particular period of time. In such a case, the quantity of carbon credits earned may be determined based at least on the amount of power reduced to each device, the respective duty cycle of each service point, and the generation mix. Still further, each service point may have multiple duty cycles determined as percentages of time that all devices located at the service point are consuming power during particular periods of time. In this case, the quantity of carbon credits earned may be determined based at least on the amount of power reduced to each device, the multiple duty cycles of each service point, and the generation mix.

According to a further embodiment, a service point may include at least one power generating device that generates electricity during one or more periods of time and supplies the generated electricity to the power grid, and may further include at least one client device that interfaces between the power generating device and a controller. According to this embodiment, the controller receives, from the client device, data regarding an amount of power generated by the power generating device and at least one time period during which the amount of power was generated and supplied to the power grid. The controller then determines net power consumed by the power consuming devices at the service point as power consumed by the devices less power generated by the power generating device.

According to a further alternative embodiment, a first service point includes a first client device and has a power storage device temporarily located thereat. Additionally, a controller is located remotely from the first service point and receives a first notification from the first client device indicating that the power storage device received power (e.g., from the power grid and/or from a local power generating device) while located at the first service point. In particular, the first notification indicates an identifier for the power storage device, an amount of power supplied to the power storage device, and a first time period associated with the supply of power to the power storage device. The controller determines the amount of power supplied to the power storage device during the first time period based on the first notification. The controller also determines a first generation mix relating to the amount of power supplied to the power storage device. The controller further receives, from a second client device located at a second service point, a second notification indicating that the power storage device dispatched power to the power grid. In particular, the second notification indicates the identifier for the power storage device, an amount of power dispatched to the power grid, and a second time period associated with the dispatch of power from the power storage device to the power grid. The controller determines the amount of power dispatched to the power grid from the power storage device during the second time period based on the second notification. The controller also determines a second generation mix relating to power supplied by the power grid during the second time period to a service area in which the second service point is located. The controller then determines net carbon credits earned with respect to dispatch of power from the power storage device based on the amount of power supplied to the power storage device, the first generation mix, the second generation mix, and the amount of power dispatched to the power grid by the power storage device, and stores the net carbon credits earned in a database entry associated with an owner of the power storage device.

According to an alternative embodiment, the present invention provides a method for determining renewable energy credits earned as a result of a control event in which power is reduced to at least one service point connected to a power grid serviced by at least one utility. According to the method of this embodiment, power consumed by at least one device located at the service point or points is determined during at least one period of time to produce power consumption data. The power consumption data is then stored (e.g., in a database or other repository). At some later point in time, a control event is initiated during which power is reduced to one or more devices at the service points. The control event may be initiated in response to a command from a utility, stored customer personal settings, a separate request from a customer, or otherwise. An amount of power reduced during the control event is then determined based on the stored power consumption data. Line loss is determined between a power generating plant of the utility (e.g., the power generating plant supplying the electricity to the service point) and the service point. A quantity of renewable energy credits earned is then determined based at least on the amount of power saved and the line loss.

According to another alternative embodiment, an apparatus is provided for controlling consumption of power produced by at least one utility that provides electrical service to at least one service point. Each service point includes one or more devices that consume power during operation thereof. The apparatus includes at least a database and a processor. The processor is operable to determine, during at least one period of time, power consumed by the devices to produce power consumption data. The processor stores the power consumption data in the database. At some later point in time, the processor is operable to initiate a control event during which power is reduced to one or more of the devices at the service point. The processor then determines an amount of power reduced during the control event based on the stored power consumption data. The processor is also operable to determine a generation mix for power that would have been supplied to the devices involved in the control event during a time period of the control event if the control event had not occurred. The processor is further operable to determine a quantity of carbon credits earned based at least on the amount of power reduced and the generation mix.

According to yet another alternative embodiment, an apparatus is provided for controlling consumption of power produced by at least one utility that provides electrical service to at least one service point. Each service point includes one or more devices that consume power during operation thereof. The apparatus includes at least a database and a processor. The processor is operable to determine, during at least one period of time, power consumed by the devices to produce power consumption data. The processor stores the power consumption data in the database. At some later point in time, the processor is operable to initiate a control event during which power is reduced to one or more of the devices at the service point. The processor then determines an amount of power reduced during the control event based on the stored power consumption data. The processor is also operable to determine a line loss between a power generating plant of the utility and the service point or points at which the devices involved in the control event are located. The processor is further operable to determine a quantity of renewable energy credits earned based at least on the amount of power reduced and the line loss.

According to a further alternative embodiment, an system is provided for controlling consumption of power produced by at least one utility that provides electrical service to at least one service point. Each service point includes one or more devices that consume power during operation thereof. The system includes an active load client device and an active load director. The active load client device is operably coupled to the power consuming devices and includes, among other things, a communications interface and a device control manager. The communications interface is operable to communicate information from which power consumed by the devices may be determined and to receive control signals relating to a control event in which power is to be reduced to the devices. The device control manager is operably coupled to the communications interface and is operable to control a flow of power to the devices responsive to the control signals and to acquire, from at least one load controller associated with the devices, the information from which power consumed by the devices may be determined. In one optional embodiment, the system includes the load controller(s). The active load director is located remotely from the active load client device and includes, among other things, an active load client device interface, a database, and a processor. The active load client device interface is operable to communicate the control signals to the active load client device and to receive the information from which power consumed by the devices may be determined. The processor is operable to determine power consumed by the devices based on the received information and to store the power consumption data in the database. The processor is also operable to generate a control signal relating to a control event during which power is to be reduced to the devices. The processor is further operable to determine an amount of power reduced during the control event based on the stored power consumption data and determine a generation mix for power that would have been supplied to the devices during a time period of the control event if the control event had not occurred. The processor is also operable to determine a quantity of carbon credits earned based at least on the amount of power reduced and the generation mix.

### BRIEF DESCRIPTION OF THE DRAWINGS

The accompanying figures, where like reference numerals refer to identical or functionally similar elements throughout the separate views and which together with the detailed description below are incorporated in and form part of the disclosure, serve to further illustrate various embodiments and to explain various principles and advantages all in accordance with the present invention.

FIG. 1 is a block diagram of an exemplary IP-based, active load management system in accordance with one embodiment of the present invention.

FIG. 2 is a block diagram illustrating an exemplary active load director as used in the active load management system of FIG. 1.

FIG. 3 is a block diagram of a system for implementing a virtual electric utility using the active load management system of FIG. 1, in accordance with an alternative embodiment of the present invention.

FIG. 4 is a block diagram illustrating an exemplary active load client and residential or smart breaker load center as used in the active load management system of FIG. 1.

FIG. 5 is a block diagram of selected portions of the active load management system of FIG. 1 and identifies various power consuming and power generation devices, variability factors, and operational parameters that contribute toward the determination of carbon credits and renewable energy credits by the active load management system, in accordance with one embodiment of the present invention.

Skilled artisans will appreciate that elements in the figures are illustrated for simplicity and clarity and have not necessarily been drawn to scale. For example, the dimensions of some of the elements in the figures may be exaggerated alone or relative to other elements to help improve the understanding of the various embodiments of the present invention.

### DETAILED DESCRIPTION

Before describing in detail exemplary embodiments that are in accordance with the present invention, it should be observed that the embodiments reside primarily in combinations of apparatus components and processing steps related to actively managing power loading on an individual service point, group of service points, and/or entire utility basis and determining carbon credits and renewable energy credits as a result of such active load management. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms, such as “first” and “second,” “top” and “bottom,” and the like, may be used solely to distinguish one entity or element from another entity or element without necessarily requiring or implying any physical or logical relationship or order between such entities or elements. The terms “comprises,” “comprising,” or any other variation thereof are intended to cover a non-exclusive inclusion, such that a process, method, article, or apparatus that comprises a list of elements does not include only those elements, but may include other elements not expressly listed or inherent to such process, method, article, or apparatus. The term “plurality of” as used in connection with any object or action means two or more of such object or action. A claim element proceeded by the article “a” or “an” does not, without more constraints, preclude the existence of additional identical elements in the process, method, article, or apparatus that includes the element.

Additionally, the term “ZigBee” refers to any wireless communication protocol adopted by the Institute of Electronics & Electrical Engineers (IEEE) according to standard 802.15.4 or any successor standard(s), and the term “Bluetooth” refers to any short-range communication protocol implementing IEEE standard 802.15.1 or any successor standard(s). Power line communications refer to any communication of data using power lines, including, but not limited to, Broadband over PowerLine (BPL) in its various forms, including through specifications promulgated or being developed by the HOMEPLUG Powerline Alliance and the Institute of Electrical and Electronic Engineers (IEEE). The term “High Speed Packet Data Access (HSPA)” refers to any communication protocol adopted by the International Telecommunication Union (ITU) or another mobile telecommunications standards body referring to the evolution of the Global System for Mobile Communications (GSM) standard beyond its third generation Universal Mobile Telecommunications System (UMTS) protocols. The term “Code Division Multiple Access (CDMA) Evolution Data-Optimized (EVDO) Revision A (CDMA EVDO Rev. A)” refers to the communication protocol adopted by the ITU under standard number TIA-856 Rev. A. The term “Long Term Evolution (LTE)” refers to any communication protocol based on Third Generation Partnership Project (3GPP) Release 8 (from the ITU) or another mobile telecommunications standards body referring to the evolution of GSM-based networks to voice, video and data standards anticipated to be replacement protocols for HSPA and EVDO.

The terms “utility,” “electric utility,” “power utility,” and “electric power utility” refer to any entity that generates and distributes electrical power to its customers, that purchases power from a power-generating entity and distributes the purchased power to its customers, or that supplies electricity created actually or virtually by alternative energy sources, such as solar power, wind power or otherwise, to power generation or distribution entities through the Federal Energy Regulatory Commission (FERC) electrical grid or otherwise. The term “environment” refers to general conditions, such as air temperature, humidity, barometric pressure, wind speed, rainfall quantity, water temperature, and so forth, at or proximate a service point or associated with a device (e.g., water temperature of water in a hot water heater or a swimming pool). The term “device,” as used herein, means a power-consuming device and any associated control component thereof or therefor, such as a control module located within a power consuming device or a remote smart breaker. There may generally be two different types of devices within or located at a service point, namely, an environmentally-dependent device and an environmentally-independent device. An environmentally-dependent device is any power consuming device that turns on or off, or modifies its behavior, based on one or more sensors that detect characteristics or conditions, such as temperature, humidity, pressure, or various other characteristics or conditions, of an environment. An environmentally-dependent device may directly affect and/or be affected by the environment in which it operates. An environmentally-independent device is any power-consuming device that turns on or off, or modifies its behavior, without reliance upon inputs from any environmental sensors. Generally speaking, an environmentally-independent device does not directly affect, and is not typically affected by, the environment in which it operates; although, as one of ordinary skill in the art will readily recognize and appreciate, operation of an environmentally-independent device can indirectly or incidentally affect, or occasionally be affected by, the environment. For example, as those skilled in the art readily understand, refrigerators and other appliances generate heat during ordinary operation, thereby causing some heating of the ambient air proximate the device. The term “credits” refers to carbon credits and/or renewable energy credits, regardless of how computed. The terms “energy” and “power” are used interchangeably herein.

It will be appreciated that embodiments or components of the systems described herein may be comprised of one or more conventional processors and unique stored program instructions that control the one or more processors to implement, in conjunction with certain non-processor circuits, some, most, or all of the functions for managing power load distribution and determining carbon credits and renewable energy credits as described herein. The non-processor circuits may include, but are not limited to, radio receivers, radio transmitters, antennas, modems, signal drivers, clock circuits, power source circuits, relays, meters, smart breakers, current sensors, and user input devices. As such, these functions may be interpreted as steps of a method to distribute information and control signals between devices in a power load management system. Alternatively, some or all functions could be implemented by a state machine that has no stored program instructions, or in one or more application specific integrated circuits (ASICs), in which each function or some combinations of functions are implemented as custom logic. Of course, a combination of the foregoing approaches could be used. Thus, methods and means for these functions have been described herein. Further, it is expected that one of ordinary skill in the art, notwithstanding possibly significant effort and many design choices motivated by, for example, available time, current technology, and economic considerations, when guided by the concepts and principles disclosed herein, will be readily capable of generating such software instructions, programs and integrated circuits (ICs), and appropriately arranging and functionally integrating such non-processor circuits, without undue experimentation.

Generally, the present invention encompasses a system and method for determining measurable, reportable, and verifiable carbon credits and/or renewable energy credits. According to one embodiment, energy use data for a service point, a group of service points (e.g., as may collectively form an electric cooperative or residents receiving electrical power from a municipality), or all service points served by a utility is measured or acquired remotely over at least one period of time (e.g., part of a day, one day, several days, a month, several months, a year, etc.). The service point or points include one or more devices, which may have power thereto reduced or interrupted during a control event initiated by a controller. The control event may be responsive to a command from a utility (which may include a complete energy conservation program providing times and durations for a series of control events over time), customer personal settings (which may also include a complete energy conservation program), or other stimulus. The measured or sampled data is stored in a database or other repository accessible by the controller (e.g., within the controller). At some point in time, a control event is initiated by the controller and power is reduced or interrupted to one or more devices at one or more service points. The amount of power reduced to a service point, and correspondingly saved by the service point, as a result of participation in the control event is determined. The generation mix of the saved power (e.g., the power that would have been supplied to the service point in the absence of the control event) is estimated or otherwise determined based on the various types of generation capability of the utility supplying the power. For example, the generation mix may be determined based on a generation mix used and/or acquired to supply power to other service points during the time period of the control event (i.e., the generation mix used to supply service points that are not affected by or part of the control event). A quantity of carbon credits and/or renewable energy credits is then determined based on the amount of power saved and its estimated generation mix. The quantity of credits may be adjusted to account for the return or supply of power to the utility's power grid through net metering and/or from energy storage devices (e.g., batteries in hybrid or fully electric vehicles) connected to the grid. The quantity of credits may also be determined to account for the additional power saved by a utility resulting from the avoidance of losses in grid transmission lines as a consequence of reducing the amount of power delivered to one or more service points during a control event.

By determining credits in this manner, the present invention provides a mechanism that generally complies with the Kyoto Protocol as proposed for implementation in the Bali Roadmap because the power reduction provided by a control event and is measurable, reportable, and verifiable. Additionally, the present invention provides for determination of credits on a service point-by-service point basis, on a utility-wide basis, and for groups of service points (e.g., as may be served by a municipality or an electric cooperative that has entered into a supply agreement with a power generating utility).

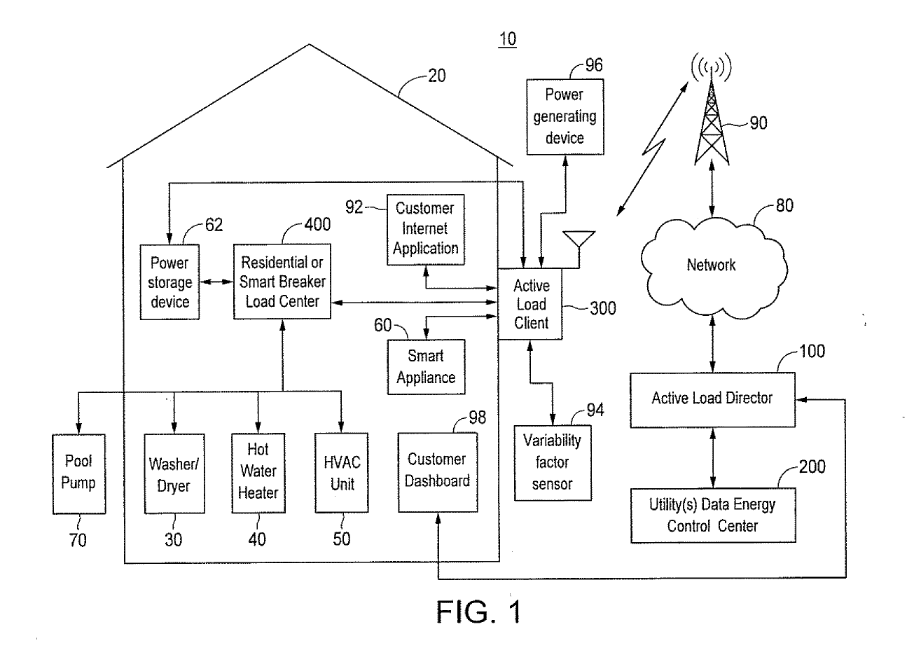

The present invention can be more readily understood with reference to FIGS. 1-4, in which like reference numerals designate like items. FIG. 1 depicts an exemplary IP-based active load management system (ALMS) 10 that may be utilized by an electric utility, which may be a conventional power-generating utility or a virtual utility, in accordance with the present invention. The below description of the ALMS 10 is limited to specific disclosure relating to embodiments of the present invention. A more general and detailed description of the ALMS 10 is provided in commonly-owned U.S. Pat. No. 7,715,951, which was first published as U.S. Patent Application Publication No. US 20090062970 A1 on Mar. 5, 2009 and is incorporated herein by this reference as if fully set forth herein. The disclosure of U.S. Patent Application Publication No. US 20090062970 provides details with respect to the exemplary operational implementation and execution of control events to interrupt or reduce power to devices located at service points, such as residences and businesses. The disclosure of U.S. Patent Application Publication No. US 20090062970 also provides a description related to the determination of carbon or other greenhouse gas emission credits or offsets based on power saved as a result of control events.

The use of an ALMS 10 to implement a virtual utility is described in detail in co-pending and commonly-owned U.S. application Ser. No. 12/001,819, which was filed on Dec. 13, 2007, was published as U.S. Patent Application Publication No. US 20090063228 A1 on Mar. 5, 2009, and is incorporated herein by this reference as if fully set forth herein. Similar to the disclosure of U.S. Patent Application Publication No. US 20090062970, the disclosure of U.S. Patent Application Publication No. US 20090063228 also provides a description related to the determination of carbon or other greenhouse gas emission credits or offsets based on power saved as a result of control events; however, the description provided in U.S. Patent Application Publication No. US 20090063228 further introduces a utility's generation mix into the credits or offsets determination, as well as describes an inter-utility communication protocol for communicating the credits or offsets between utilities. Further, the virtual electric utility disclosed in U.S. Patent Application Publication No. US 20090063228 enables independent power producers (IPPs), electric cooperatives, municipalities and other non-power generating electric utilities or other entities, whether regulated or unregulated, to benefit from power conservation and carbon footprint reduction. The present invention improves upon the disclosures of U.S. Patent Application Publication No. US 20090062970 and U.S. Patent Application Publication No. US 20090063228 to provide a load-control implementation of the Kyoto Protocol that enables measurable, reportable, and verifiable determination of power saved and credits earned, as well as supports net metering and the use of power storage devices at customer service points. Thus, the ALMS 10 disclosed herein may provide additional sources of power to a power utility while reducing emissions of carbon dioxide and other greenhouse gases.

The exemplary ALMS 10 monitors and manages power distribution via an active load director (ALD) 100 connected between one or more utility control centers (UCCs) 200 (one shown) and one or more active load clients (ALCs) 300 (one shown) installed at one or more service points 20 (one shown). The ALD 100 may communicate with the utility control center 200 and each active load client 300 either directly or through a network 80 using the Internet Protocol (IP) or any other (IP or Ethernet) connection-based protocols. For example, the ALD 100 may communicate using RF systems operating via one or more base stations 90 (one shown) using one or more wireless communication protocols, such as GSM, Enhanced Data GSM Environment (EDGE), ANSI C12.22, HSPA, LTE, Time Division Multiple Access (TDMA), or CDMA data standards, including CDMA 2000, CDMA Revision A, CDMA Revision B, and CDMA EVDO Rev. A. Alternatively, or additionally, the ALD 100 may communicate wholly or partially via wired interfaces, such as through the use of digital subscriber line (DSL) technology, cable television IP-based technology, and/or other related technology. In the exemplary embodiment shown in FIG. 1, the ALD 100 communicates with one or more active load clients 300 using a combination of traditional IP-based communication (e.g., over a trunked line) to a base station 90 and a wireless channel implementing the HSPA or EVDO protocol from the base station 90 to the active load client 300. The distance between the base station 90 and the service point 20 or the active load client 300 is typically referred to as the “last mile” even though the distance may not actually be a mile. The ALD 100 may be implemented in various ways, including, but not limited to, as an individual server, as a blade within a server, in a distributed computing environment, or in other combinations of hardware and software. In the following disclosure, the ALD 100 is described as embodied in an individual server to facilitate an understanding of the present invention.

Each active load client 300 is accessible through a specified address (e.g., IP address) and controls and monitors the state of individual smart breaker modules or intelligent appliances 60 installed at the service point 20 (e.g., in the business or residence) to which the active load client 300 is associated (e.g., connected or supporting). Each active load client 300 is preferably associated with a single residential or commercial customer. In one embodiment, the active load client 300 communicates with a residential load center 400 that contains smart breaker modules, which are able to switch from an “ON” (active) state to an “OFF” (inactive) state, and vice versa, responsive to signaling from the active load client 300. Smart breaker modules may include, for example, smart breaker panels manufactured by Schneider Electric SA under the trademark “Square D” or Eaton Corporation under the trademark “Cutler-Hammer” for installation during new construction. For retro-fitting existing buildings, smart breakers having means for individual identification and control may be used. Typically, each smart breaker controls a single appliance (e.g., a washer/dryer 30, a hot water heater 40, an HVAC unit 50, or a pool pump 70). In an alternative embodiment, IP addressable relays or device controllers that operate in a similar fashion as a “smart breaker” may be used in place of smart breakers, but would be installed coincident with the load under control and may measure the startup power, steady state power, power quality, duty cycle and/or energy load profile of the individual appliance 60, HVAC unit 40, pool pump 70, hot water heater 40 or any other controlled device as determined by the utility or end customer.

Additionally, the active load client 300 may control individual smart appliances 60 directly (e.g., without communicating with the residential load center 400) via one or more of a variety of known communication protocols (e.g., IP, BPL, Ethernet, Bluetooth, ZigBee, Wi-Fi (IEEE 802.11 protocols), WiMax (IEEE 802.16 protocols), HSPA, EVDO, etc.). Typically, a smart appliance 60 includes a power control module (not shown) having communication abilities. The power control module is installed in-line with the power supply to the appliance, between the actual appliance and the power source (e.g., the power control module is plugged into a power outlet at the home or business and the power cord for the appliance is plugged into the power control module). Thus, when the power control module receives a command to turn off the appliance 60, it disconnects the actual power supplying the appliance 60. Alternatively, a smart appliance 60 may include a power control module integrated directly into the appliance, which may receive commands and control the operation of the appliance 60 directly (e.g., a smart thermostat may perform such functions as raising or lowering the set temperature, switching an HVAC unit on or off, or switching a fan on or off).

The active load client 300 may further be coupled to one or more variability factor sensors 94. Such sensors 94 may be used to monitor a variety of variability factors affecting operation of the devices, such as inside and/or outside temperature, inside and/or outside humidity, time of day, pollen count, amount of rainfall, wind speed, and other factors or parameters.

For a service point 20 associated with a business or industrial setting, the ALMS 10 may be utilized to lower power consumption during times of peak demand by cutting power to switch-based or environmentally-independent devices (such as lights in common areas and/or elevators) and reducing or increasing, as applicable depending on the set point and/or mode (heating or cooling) of the device, the temperature or other environmental characteristic under the control of environmentally-dependent devices (such as reducing heating or air conditioning in common areas, reducing furnace temperatures or increasing refrigerator temperatures).

As also shown in FIG. 1, a service point 20 may optionally have one or more power generating devices 96 (one shown) on-site, such as solar panels, fuel cells, and/or wind turbines. When included, each power generating device 96 is coupled to the active load client 300. Power supplied by the power generating device 96 may be used in whole or in part by devices at the service point 20 and any extra, unused power may be added to the utility's overall capacity. In accordance with net metering regulations, the utility may provide credit to the service point owner for any energy produced at the service point 20 and supplied to the utility's power grid.

The service point 20 may optionally further include one or more power storage devices 62 (one shown) on-site to store energy supplied by the utility or produced by the power generating device 96. The power storage device 62 may be primarily used for power storage or, more typically, may have another primary purpose, such as power consumption, although storage of power is a secondary purpose. Normally, the power storage device 62 is plugged into the power grid and incrementally stores power which can be used or consumed later. One example of a power storage device 62 is an electric vehicle. When not in use, the power storage device 62 may be plugged into an outlet at the service point 20 to draw and store energy from the utility's grid. The power storage device 62 may then be unplugged later and used for its primary purpose. In the example of an electric vehicle, the power storage device 62 is unplugged to be used for transportation. Alternatively, the power storage device 62 may, at a later time after being charged, serve as a source of power, akin to a power generating device 96. For example, an electric vehicle may be plugged into a socket at the service point 20 and have some or all of its remaining stored power supplied to the utility's grid when, for example, the vehicle owner is not planning on using the vehicle for awhile. In such a case, the vehicle owner could elect to supply power to the utility grid at high peak load times and receive or consume power from the grid at low peak load times, effectively treating stored power as a commodity.

The service point 20 may further include a web-based user interface (e.g., Internet-accessible web portal) into a web browser interface of the ALD 100. The web-based interface is referred to herein as a “customer dashboard” 98. When the customer dashboard 98 is accessed by the customer via a computer, smart phone, personal digital assistant, or other comparable device, the customer dashboard 98 may be used by the customer to specify preferences for use by the ALMS 10 to control devices at the customer's service point 20. The customer dashboard 98 effectively provides the customer with access into the ALD 100. The ALD 100 (e.g., through a web browser interface) accepts inputs from the customer dashboard 98 and outputs information to the customer dashboard 98 for display to the customer. The customer dashboard 98 may be accessed from the service point 20 or remotely from any Internet-accessible device, preferably through use of a user name and password. Thus, the customer dashboard 98 is a preferably secure, web-based interface used by customers to specify preferences associated with devices controlled by the ALD 100 and located at the customer's service point 20, as well as to provide information requested by a customer personal settings application 138 or a customer sign-up application 116 executed by the ALD 100 in connection with controlled devices and/or service point conditions or parameters. Customer preferences may include, for example, control event preferences (e.g., times, durations, etc.), bill management preferences (e.g., goal or target for maximum monthly billing cost), maximum and minimum boundary settings for environmental characteristics or conditions, and others. As shown in FIG. 1, the customer dashboard 98 may be connected to the ALD 100 via an Internet service provider for the service point 20 or may be implemented as a customer Internet application 92 when Internet service is supplied through the active load client 300 as described below and in U.S. Patent Application Publication No. US 20090063228.

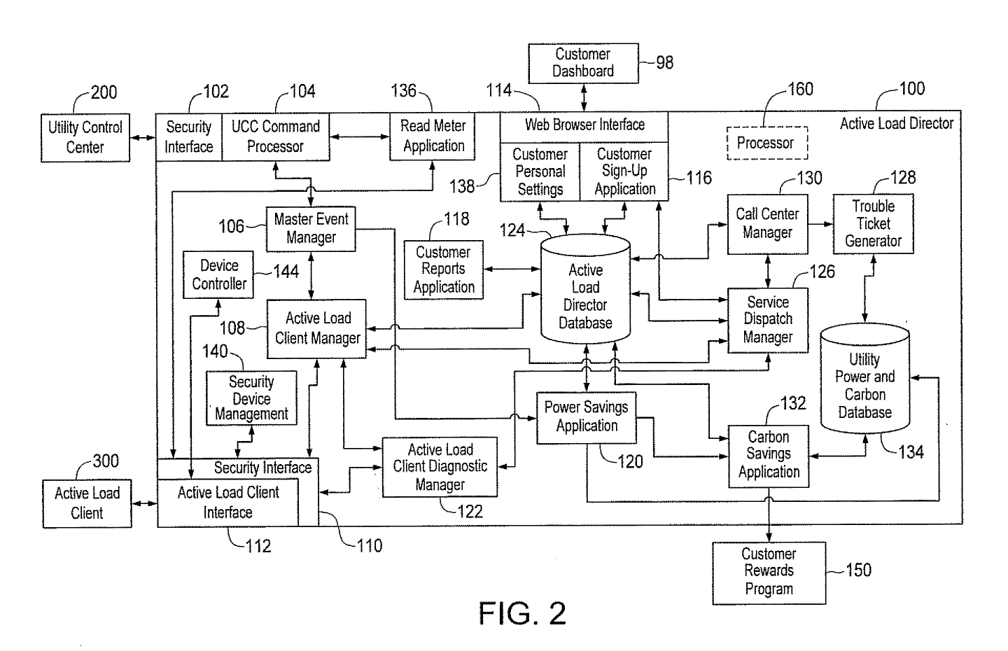

Referring now to FIG. 2, the ALD 100 may serve as the primary interface to customers, as well as to service personnel, and operates as the system controller by sending control messages to, and collecting data from, installed active load clients 300 as described in U.S. Patent Application Publication No. US 20090062970. In the exemplary embodiment depicted in FIG. 2, the ALD 100 is implemented as an individual server and includes a utility control center (UCC) security interface 102, a UCC command processor 104, a master event manager 106, an ALC manager 108, an ALC security interface 110, an ALC interface 112, a web browser interface 114, a customer sign-up application 116, customer personal settings 138, a customer reports application 118, a power savings application 120, an ALC diagnostic manager 122, an ALD database 124, a service dispatch manager 126, a trouble ticket generator 128, a call center manager 130, a carbon savings application 132, a utility power and carbon (P&C) database 134, a read meter application 136, a security device manager 140, and a device controller 144. The operational details of several of the elements of the ALD 100 are described below. The operational details of the remaining elements of the ALD 100 may be found in U.S. Patent Application Publication No. US 20090062970, U.S. Patent Application Publication No. US 20090063228, and commonly-owned, co-pending U.S. application Ser. No. 12/775,979, wherein the ALD 100 is also described in the context of an individual server embodiment. U.S. application Ser. No. 12/775,979 is entitled “System and Method for Estimating and Providing Dispatchable Operating Reserve Energy Capacity Through Use of Active Load Management,” was filed on May 7, 2010, and is incorporated herein by this reference. U.S. application Ser. No. 12/775,979 describes techniques for estimating or projecting the amount of power that could be saved during a control event taking into account customer personal settings 138.

In one embodiment, customers use the customer dashboard 98 to interact with the ALD 100 through the web browser interface 114 and subscribe to some or all of the services offered by the ALMS 10 via a customer sign-up application 116. In accordance with the customer sign-up application 116, the customer specifies customer personal settings 138 that contain information relating to the customer and the customer's service point 20 (e.g., residence or business), and defines the extent of service to which the customer wishes to subscribe. For example, as noted above, customer personal settings 138 may include, for example, control event preferences (e.g., times, durations, etc., such as to, for example, implement an energy conservation program or profile), bill management preferences (e.g., goal or target for maximum monthly billing cost), maximum and minimum boundary settings for environmental characteristics or conditions, and others. Additional details relating to the customer sign-up application 116 and the input of customer personal settings 138 are discussed below and in U.S. application Ser. No. 12/775,979. Customers may also use the customer dashboard 98 to access and modify information pertaining to their existing accounts after they have been established.

The ALD 100 also includes a UCC security interface 102 which provides security and encryption between the ALD 100 and a utility company's control center 200 to ensure that no third party is able to provide unauthorized directions to the ALD 100. A UCC command processor 104 receives and sends messages between the ALD 100 and the utility control center 200. Similarly, an ALC security interface 110 provides security and encryption between the ALD 100 and each active load client 300 in the system 10, ensuring that no third parties can send directions to, or receive information from, the active load client 300. The security techniques employed by the ALC security interface 110 and the UCC security interface 102 may include conventional symmetric key or asymmetric key algorithms, such as Wireless Encryption Protocol (WEP), Wi-Fi Protected Access (WPA and WPA2), Advanced Encryption Standard (AES), Pretty Good Privacy (PGP), or proprietary encryption techniques.

In one embodiment, the commands that can be received by the UCC command processor 104 from the electric utility's control center 200 include a “Cut” command, a “How Much” command, an “End Event” command, and a “Read Meters” command. The “Cut” command instructs the ALD 100 to reduce a specified amount of power for a specified amount of time. The specified amount of power may be an instantaneous amount of power or an average amount of power consumed per unit of time. The “Cut” command may also optionally indicate general geographic areas or specific locations for power load reduction. The “How Much” command requests information for the amount of power (e.g., in megawatts) that can be reduced by the requesting utility control center 200. The “End Event” command stops the present ALD transaction (e.g., control event). The “Read Meters” command instructs the ALD 100 to read the meters for all customers serviced by the requesting utility.

The UCC command processor 104 may send a response to a “How Much” command or an “Event Ended” status confirmation to a utility control center 200. A response to a “How Much” command returns an amount of power that can be cut. An “Event Ended” acknowledgement message confirms that the present ALD transaction has ended.

The master event manager 106 maintains the overall status of the power load activities controlled by the ALMS 10. In one embodiment, the master event manager 106 maintains a separate state for each utility that is controlled (when multiple utilities are controlled) and tracks the current power usage within each utility. The master event manager 106 may also track the management condition of each utility (e.g., whether or not each utility is currently being managed). The master event manager 106 receives instructions in the form of transaction requests from the UCC command processor 104 and routes instructions to components necessary to complete the requested transaction, such as the ALC manager 108 and the power savings application 120.

The ALC manager 108 routes instructions between the ALD 100 and each active load client 300 within the system 10 through the ALC interface 112. For instance, the ALC manager 108 may track the state of every active load client 300 serviced by specified utilities by communicating with the active load client 300 through an individual IP address. The ALC interface 112 translates instructions (e.g., transactions) received from the ALC manager 108 into the proper message structure understood by the targeted active load client 300 and then sends the message to the active load client 300. Likewise, when the ALC interface 112 receives messages from an active load client 300, it translates the message into a form understood by the ALC manager 108 and routes the translated message to the ALC manager 108.

The ALC manager 108 receives from each active load client 300 that it services, either periodically or responsive to polling messages sent by the ALC manager 108, messages containing the present power consumption (or information from which the present power consumption can be determined, such as current draw and operating voltage(s)) and the status (e.g., “ON” or “OFF”) of each device controlled by the active load client 300. Alternatively, if individual device metering is not available, then the total power consumption (or information from which the total power consumption can be determined, such as current draw and operating voltage(s)) and load management status for the entire active load client 300 may be reported. The information contained in each status message is stored in the ALD database 124 in a record associated with the specified active load client 300. The ALD database 124 preferably contains all the information necessary to manage every customer account and power distribution. In one embodiment, the ALD database 124 contains customer contact information, such as names, addresses, phone numbers, email addresses, and associated utility companies for all customers having active load clients 300 installed at their residences or businesses, as well as a description of specific operating instructions (e.g., customer preferences, such as set points and maximum permitted variances therefrom) for each managed device (e.g., IP-addressable smart breaker or appliance), device status, and device diagnostic history.

There are several types of messages that the ALC manager 108 may receive from an active load client 300 and process accordingly. One such message is a security alert message. A security alert message originates from an optional security or safety monitoring system installed at the service point 20 (e.g., in the residence or business) and coupled to the active load client 300 (e.g., wirelessly or via a wired connection). When a security alert message is received, the ALC manager 108 accesses the ALD database 124 to obtain routing information for determining where to send the alert, and then sends the alert as directed. For example, the ALC manager 108 may be programmed to send the alert or another message (e.g., an electronic mail message or a pre-recorded voice message) to a security monitoring service company and/or the owner of the residence or business.

Another message that may be communicated between an active load client 300 and the ALC manager 108 is a report trigger message. A report trigger message alerts the ALD 100 that a predetermined amount of power has been consumed by a specific device monitored by the active load client 300. When a report trigger message is received from an active load client 300, the ALC manager 108 logs the information contained in the message in the ALD database 124 for the customer associated with the information-supplying active load client 300. The power consumption information is then used by the ALC manager 108 to determine the active load client(s) 300 to which to send a power reduction or “Cut” message during a power reduction or control event.

Yet another message that may be exchanged between an active load client 300 and the ALC manager 108 is a status response message. A status response message reports the type and status of each device controlled by the active load client 300 to the ALD 100. When a status response message is received from an active load client 300, the ALC manager 108 logs the information contained in the message in the ALD database 124.

In one embodiment, upon receiving instruction (e.g., a “Cut” instruction) from the master event manager 106 to reduce power consumption for a specified utility, the ALC manager 108 determines which active load clients 300 and/or individually controlled devices to switch to the “OFF” state based upon present or prior power consumption data stored in the ALD database 124. Power consumption data may include power consumed, current drawn, duty cycle, operating voltage, operating impedance, time period of use, set points, ambient and outside temperatures during use (as applicable), and/or various other energy use or environmental data. The ALC manager 108 then sends a message to each selected active load client 300 containing instructions to turn off all or some of the devices under the active load client's control.

In another embodiment, a power savings application 120 may be optionally included to calculate the total amount of power saved by each utility during a power reduction event (also referred to herein as a “Cut event” or a control event), as well as the amount of power saved for each customer whose active load client 300 reduced the amount of power delivered to the customer's service point 20. The power savings application 120 accesses the data stored in the ALD database 124 for each customer serviced by a particular utility and stores the total cumulative power savings (e.g., in megawatts per hour) accumulated by each utility for each Cut event in which the utility participated as an entry in the utility Power and Carbon (“P&C”) database 134.

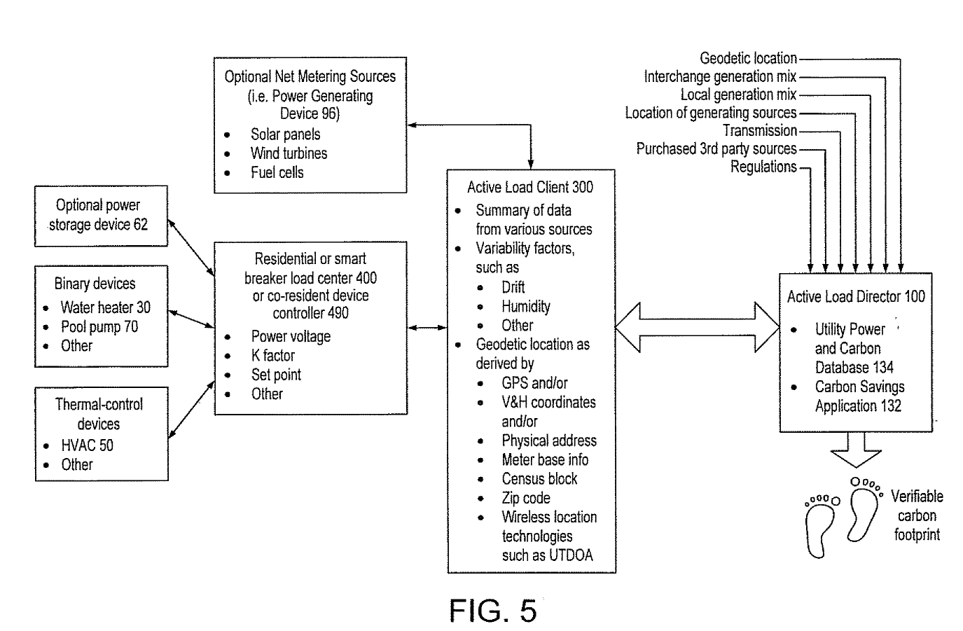

In a further embodiment, an optional carbon savings application 132 uses the information produced by the power savings application 120 to determine the amount of carbon dioxide or carbon dioxide equivalents saved by each utility and by each customer for every Cut event. Carbon savings information, such as type of fuel that was used to generate power for the customer set that was included in the just completed control event, power saved as a result of the control event, governmental standard or other calculation rates, and/or other data (e.g., generation mix per serving utility and geography of the customer's location and the location of the nearest power source), is stored in the ALD database 124 for each active load client 300 (customer) and in the utility P&C database 134 for each utility. The carbon savings application 132 calculates the total equivalent carbon credits saved for each active load client 300 (customer) and utility participating in the previous Cut event, and stores the information in the ALD database 124 and the utility P&C database 134, respectively. The determination of credits by the carbon savings application 132 is described in more detail below with respect to FIG. 5. The carbon savings application 132 is preferably implemented as a set of computer instructions (software) stored in a memory (not shown) of the ALD 100 and executed by one or more processors 160 (one shown) of the ALD 100.

A read meter application 136 may be optionally invoked when the UCC command processor 104 receives a “Read Meters” or equivalent command from the utility control center 200. The read meter application 136 cycles through the ALD database 124 and sends a read meter message or command to each active load client 300, or those active load clients 300 specifically identified in the UCC's command, via the ALC manager 108. The information received by the ALC manager 108 from the active load client 300 is logged in the ALD database 124 for each customer. When all the active load client meter information has been received, the information is sent to the requesting utility control center 200 using a business to business (e.g., ebXML) or other desired protocol.

In a further embodiment, the ALD server 100 also includes a customer reports application 118 that generates reports to be sent to individual customers detailing the amount of power saved during a previous billing cycle. Each report may contain a cumulative total of power savings over the prior billing cycle, details of the amount of power saved per controlled device (e.g., breaker or appliance), power savings from utility-directed control events, power savings from customer-directed control events (e.g., as a result of customer personal settings 138), devices being managed, total carbon equivalents used and saved during the billing period, and/or specific details for each Cut event in which the customer's active load client 300 participated. Customers may also receive incentives and awards for participation in the ALMS 10 through a customer rewards program 150. For example, the utilities or a third party system operator may enter into agreements with product and/or service providers to offer system participants discounts on products and services offered by the providers based upon certain participation levels or milestones. The rewards program 150 may be setup in a manner similar to conventional frequent flyer programs in which points are accumulated for power saved (e.g., one point for each megawatt saved or deferred) and, upon accumulation of predetermined levels of points, the customer can select a product or service discount. Alternatively, a serving utility may offer a customer a rate discount for participating in the ALMS 10.

In one embodiment of the present invention, the utility or the ALD 100 determines the amount of carbon credits or offsets relating to carbon dioxide, sulfur dioxide, nitrous oxide, mercury, or other greenhouse gas emissions, which are associated with the electric power saved as the result of one or more control events. The carbon credits for greenhouse gases other than carbon dioxide are computed by converting the quantities of saved emissions by appropriate published conversion factors to obtain carbon dioxide (CO₂) equivalents, or CO₂e. The terms “carbon credits” and “carbon offsets” as used herein shall include credits or offsets associated with emissions of carbon dioxide and other greenhouse gases as converted into carbon dioxide equivalents.

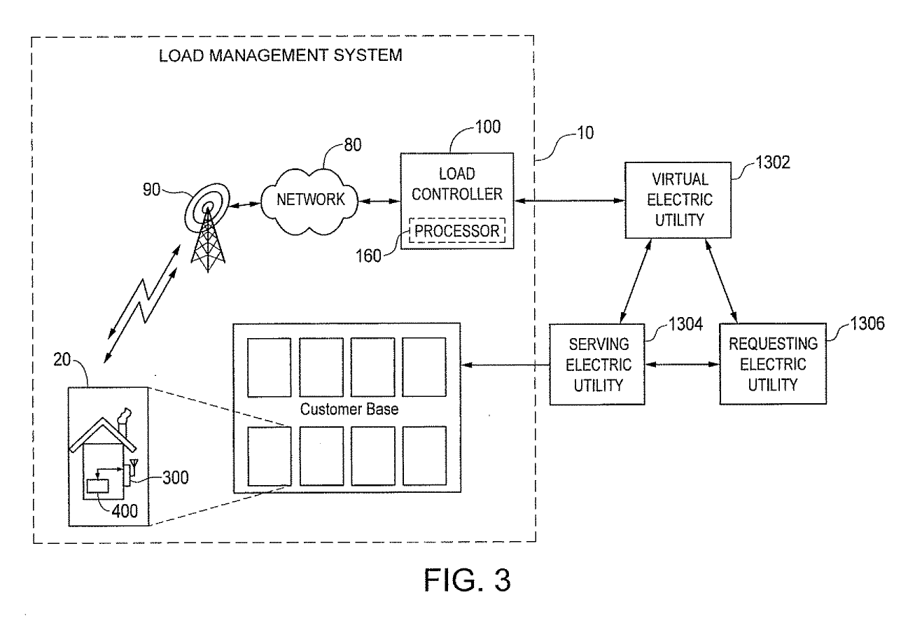

The utility may offer to sell at least some of the carbon credits or offsets on an open market, under agreements with other electric utilities, or otherwise. For example, a virtual electric utility 1302 as described in U.S. Patent Application Publication No. US 20090063228 and illustrated in FIG. 3 (which is essentially FIG. 9 of U.S. Patent Application Publication No. US 20090063228) may trade or otherwise monetize the accumulated carbon credits or offsets through various commercial means, such as through one of the newly created credit or offset trading exchanges that have recently emerged on the European and American commodities exchanges. Alternatively, the virtual utility 1302 may agree to sell or offer to sell its carbon credits to other electric utilities 1304, 1306, including, for example, the power generating utility (e.g., utility 1304) with which the virtual utility 1302 has entered in to an electric power supply agreement as described in more detail in U.S. Patent Application Publication No. US 20090063228.

The amount of carbon credits or offsets accumulated by deferring or reducing power consumption is a function of the amount of power deferred or saved in combination with the generation mix of the serving utility that provides electricity to customers within a pre-defined geographic area and affected by a control event. The generation mix identifies the energy (e.g., fuel) sources providing the overall capability of each serving utility to supply electricity at any given time. For instance, a serving utility may, at the time of a particular control event, obtain 31% of its overall capacity from burning coal, 6% from oil, 17% from nuclear facilities, 1% from hydroelectric plants, and the remaining 45% from clean technologies, such as natural gas or renewable energy sources (e.g., solar power or wind power). The generation mix is generally known in real time by the serving utility. However, due to the inherent delay associated with using the utility's transmission grid to convey power to and from various FERC-grid interconnected locations, historical data regarding the generation mix may be used to compute carbon credits on a delayed or non-real time basis after the actual events of conservation (e.g., one or more control events), trading or generation of the electricity. Alternatively, carbon credits or offsets may be determined by the virtual utility 1302 in real time based on real time generation mix data from the serving utility 1304.

Because carbon credits relate only to the amount of carbon burned, each energy type has a different carbon credit rating. Consequently, the carbon value is determined by the make-up of the energy sources for the serving utility. Actual carbon credits accumulated by power load deferment may be calculated, for example, through execution of the carbon savings application 132 by a processor 160 of the ALD 100 or through other commercially viable load management or curtailment methods, such as large commercial industrial direct load control programs, which determine the actual load consumption deferred by each customer. Carbon credits or offsets, or credits or offsets for other greenhouse gas emissions, may be calculated based on the Kyoto Protocol, according to federal or state mandated methods, or according to a method agreed upon by an association or group of electric utilities. A detailed description of how carbon credits may be determined in accordance with embodiments of the present invention is provided below with respect to FIG. 5.

Carbon credits or other fuel or gaseous emissions-based credits may be calculated and allocated on a customer-by-customer basis or cumulatively for the serving utility 1304. When allocated on a customer-by-customer basis, each customer may sell or exchange the carbon or other credits or offsets resulting from that customer's participation in the ALMS 10. When the credits are retained by the utility, the utility may exchange the carbon or other credits with other electric utilities using a dedicated inter-utility communication signaling protocol, such as discussed above and in U.S. Patent Application Publication No. US 20090063228.

Additionally, customer reward points and carbon or other fuel or gaseous emissions-based credits may be exchanged on other commodity exchanges resembling carbon trading exchanges but not necessarily directly related to carbon credits. An example of this type of exchange would be environmentally friendly companies providing “phantom carbon credits” in exchange for actual carbon credits that are retained by the virtual utility 1302 and its trading partners.

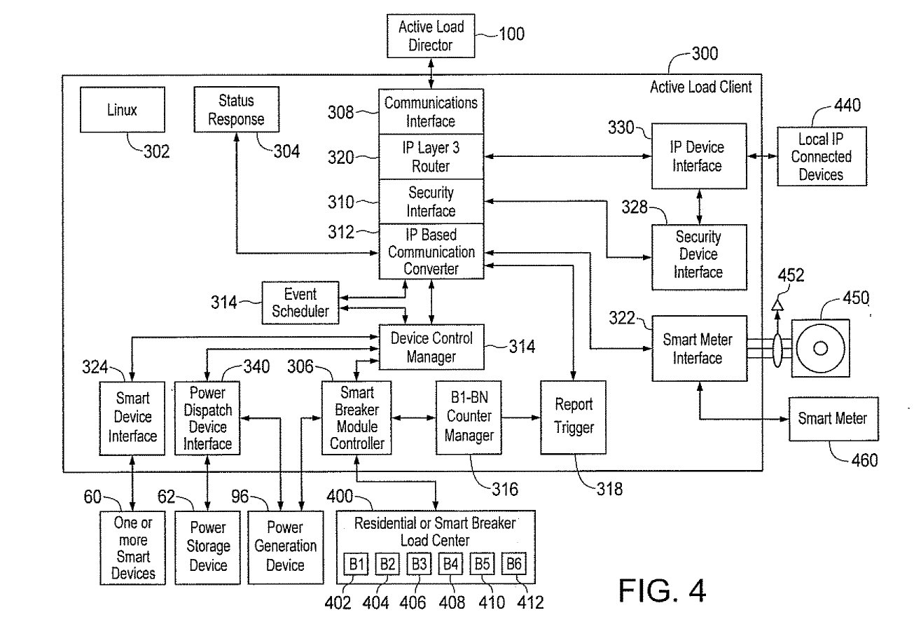

FIG. 4 illustrates a block diagram of an exemplary active load client 300 and residential load center 400 as used in accordance with one embodiment of the ALMS 10 of FIG. 1. The depicted active load client 300 includes a Linux-based operating system 302, a status response generator 304, a smart breaker module controller 306, a communications interface 308, a security interface 310, an IP-based communication converter 312, a device control manager 314, a smart breaker (B1-BN) counter manager 316, an IP router 320, a smart meter interface 322, a smart device interface 324, an IP device interface 330, and a power dispatch device interface 340. The active load client 300, in this embodiment, is a computer or processor-based system located on-site at a service point 20 (e.g., customer's residence or business). The primary function of the active load client 300 is to manage the power load levels of controllable devices located at the service point 20, which the active load client 300 oversees and controls on behalf of the customer. In an exemplary embodiment, the active load client 300 may include dynamic host configuration protocol (DHCP) client functionality to enable the active load client 300 to dynamically request IP addresses for itself and/or one or more controllable devices 402-412, 60 managed thereby from a DHCP server on the host IP network facilitating communications between the active load client 300 and the ALD 100. The active load client 300 may further include router functionality and maintain a routing table of assigned IP addresses in a memory of the active load client 300 to facilitate delivery of messages from the active load client 300 to the controllable devices 402-412, 60. The active load client 300 may further include power dispatch functionality (e.g., power dispatch device interface 340) and provide information to the ALD 100 regarding power available for dispatch from a power generation device 96 and/or a power storage device 62 at the service point 20.

A communications interface 308 facilitates connectivity between the active load client 300 and the ALD 100. Communication between the active load client 300 and the ALD 100 may be based on any type of IP or other connection protocol, including but not limited to, the WiMax protocol. Thus, the communications interface 308 may be a wired or wireless modem, a wireless access point, or other appropriate interface.

A standard IP Layer-3 router 320 routes messages received by the communications interface 308 to both the active load client 300 and to any other locally connected IP device 440. The router 320 determines if a received message is directed to the active load client 300 and, if so, passes the message to a security interface 310 to be decrypted. The security interface 310 provides protection for the contents of the messages exchanged between the ALD 100 and the active load client 300. The message content is encrypted and decrypted by the security interface 310 using, for example, a symmetric encryption key composed of a combination of the IP address and GPS data for the active load client 300 or any other combination of known information. If the message is not directed to the active load client 300, then it is passed to the IP device interface 330 for delivery to one or more locally connected devices 440. For example, the IP router 320 may be programmed to route power load management system messages as well as conventional Internet messages. In such a case, the active load client 300 may function as a gateway for Internet service supplied to the residence or business instead of using separate Internet gateways or routers. When functioning to route both ALMS messages and conventional Internet messages (e.g., as a gateway for general Internet service), the IP router 320 may be programmed with a prioritization protocol that provides priority to the routing of all ALMS messages or at least some ALMS messages (e.g., those associated with control events).

An IP based communication converter 312 opens incoming messages from the ALD 100 and directs them to the appropriate function within the active load client 300. The converter 312 also receives messages from various active load client 300 functions (e.g., device control manager 314, status response generator 304, and report trigger application 318), packages the messages in the form expected by the ALD 100, and then passes them on to the security interface 310 for encryption.

The device control manager 314 processes power management commands for control components of various controllable devices logically connected to the active load client 300. The control components can be smart breakers 402-412 (six shown) or controllers of smart devices 60, such as control modules of smart appliances. Each smart breaker component 402-412 is associated with at least one device and may be implemented as a load controller. A load controller may be configured to: (i) interrupt or reduce power to one or more associated devices during a control event, (ii) sense power demand during a control event, (iii) detect power generation from an associated device (when the associated device is a power generation device 96), (iv) sense conditions or characteristics (e.g., temperature, humidity, light, etc.) of an environment in which the associated device is operating, (v) detect device degradation or end of life, (vi) communicate with other device controllers at the service point 20 and/or within the ALMS 10, and/or (vii) validate operating performance of its associated device or devices. The load controller as implemented with a smart breaker 402-412 can manage multiple devices.

The device control manager 314 also processes “Query Request” or equivalent commands or messages from the ALD 100 by querying a status response generator 304, which maintains the type and status of each device controlled by the active load client 300, and providing the statuses to the ALD 100. The “Query Request” message may include information other than mere status requests. For example, the “Query Request” message may include information relating to customer personal settings 138, such as temperature or other environmental characteristic set points for environmentally-dependent devices, time intervals during which load control is permitted or prohibited, dates during which load control is permitted or prohibited, and priorities of device control (e.g., during a power reduction control event, hot water heater and pool pump are turned off before HVAC unit is turned off). If temperature set points or other non-status information are included in a “Query Request” message and there is a device 60 attached to the active load client 300 that can process the information, the temperature set points or other information are sent to that device 60 via the smart device interface 324.

The status response generator 304 receives status messages from the ALD 100 and, responsive thereto, polls each device under the active load client's control to determine whether the device is active and in good operational order. Each device (e.g., through its associated controller) responds to the polls with operational information (e.g., activity status and/or error reports) in a status response message. The active load client 300 stores the status responses in a memory associated with the status response generator 304 for reference in connection with control events.

The smart device interface 324 facilitates IP or other address-based communications to individual devices 60 (e.g., smart appliance power control modules) that are attached to the active load client 300. The connectivity can be through one of several different types of networks, including but not limited to, BPL, ZigBee, Wi-Fi, Bluetooth, or direct Ethernet communications. Thus, the smart device interface 324 is a modem adapted for use in or on the network connecting smart devices 60 to the active load client 300. The smart device interface 324 also allows the device control manager 314 to manage those devices that have the capability to sense temperature settings and respond to variations in temperature or other environmental characteristics or conditions.

The smart breaker module controller 306 formats, sends, and receives messages to and from the smart breaker module or load center 400. In one embodiment, the communication is preferably through a BPL connection. In such embodiment, the smart breaker module controller 306 includes a BPL modem and operations software. The smart breaker module 400 contains individual smart breakers 402-412, wherein each smart breaker 402-412 includes an applicable modem (e.g., a BPL modem when BPL is the networking technology employed) and is preferably in-line with power supplied to a single appliance or other device. The B1-BN counter manager 316 determines and stores real time power usage for each installed smart breaker 402-412. For example, the counter manager 316 tracks or counts the amount of power used through each smart breaker 402-412 and stores the counted amounts of power in a memory of the active load client 300 associated with the counter manager 316. When the counter for any breaker 402-412 reaches a predetermined limit, the counter manager 316 provides an identification number corresponding to the smart breaker 402-412 and the corresponding amount of power (power number) to the report trigger application 318. Once the information is passed to the report trigger application 318, the counter manager 316 resets the counter for the applicable breaker 402-412 to zero so that information can once again be collected. The report trigger application 318 then creates a reporting message containing identification information for the active load client 300, identification information for the particular smart breaker 402-412 or device associated therewith, and the power number, and sends the report to the IP based communication converter 312 for transmission to the ALD 100. The ALD 100 stores the power consumption data in the ALD database 124 or some other repository as described in detail in U.S. application Ser. No. 12/775,979, which is incorporated herein by this reference.

The smart meter interface 322 manages either smart meters 460 that communicate using BPL or a current sensor 452 connected to a traditional power meter 450. When the active load client 300 receives a “Read Meters” command or message from the ALD 100 and a smart meter 460 is attached to the active load client 300, a “Read Meters” command is sent to the meter 460 via the smart meter interface 322 (e.g., a BPL modem). The smart meter interface 322 receives a reply to the “Read Meters” message from the smart meter 460, formats this information along with identification information for the active load client 300, and provides the formatted message to the IP based communication converter 312 for transmission to the ALD 100.

FIG. 5 is a block diagram of selected portions of the ALMS 10 and identifies various power consuming and power generation devices, variability factors, and operational parameters that contribute toward the determination of carbon credits and renewable energy credits by the ALMS 10 (e.g., via the ALD 100), in accordance with one embodiment of the present invention. Power consumption data for a variety of devices at the service point 20 is used to determine carbon credits for the service point 20. The power consumption data may relate to environmentally-independent devices (such as a water heater 30, a pool pump 70, or a water softener), environmentally-dependent devices (such as an HVAC 50, a temperature-dependent water heater or pool heater, or a sprinkler system pump with a rain sensor), and/or power storage devices 62 (e.g., an electric vehicle if connected to an outlet at the service point 20). The power consumption data is transmitted to, measured by, or otherwise acquired by the residential or smart breaker load center 400 or a co-resident device controller and may include power consumed, operating voltage, current drawn, k-factor (e.g., an industry-recognized numerical rating given to electrical transmission equipment that relates to the equipment's ability to maintain and transmit electricity), set point(s), and other data associated with operation of electrical power consuming or distributing devices. The power consumption data is sent to the active load client 300 using IP Ethernet, BPL or other known communication protocols.

The active load client 300 receives the power consumption data from the residential or smart breaker load center 400, as well as any data from power generation devices 96 at the service point 20. The active load client 300 optionally supplements the received data with variability factors (e.g., drift, humidity, temperature, and others) as detected from variability factor sensors 94 installed at the service point 20, as described in more detail in U.S. application Ser. No. 12/775,979), and/or with geodetic location data (e.g., GPS coordinates, vertical and horizontal (V&H) coordinates, physical address, meter base information, census block, zip code, and/or data derived from wireless location technologies, such as uplink time difference of arrival (UTDOA)). The power consumption data, as optionally supplemented with variability factors and geodetic data, is collected for the service point 20 and communicated to the ALD 100 using IP Ethernet or another known communication protocol.

In one embodiment, the ALD 100 determines carbon credits for the service point 20 using the received power consumption data and optionally additional information obtained from other sources. This additional information may include:
Geodetic location (if not supplied by the active load client 300);
Interchange generation mix (e.g., obtained from the sourcing utilities for power obtained from other sources);
Local generation mix;
Location of generating sources;
Transmission data (e.g., line losses associated with delivery of power to the service point 20 or to a service area that includes the service point 20);
Energy purchased from third party sources and the generation mix of such energy;
Regulations from governing authorities; and/or
Weather or other environmental conditions.
   All of the received and collected data and information may be stored in the ALD's utility power and carbon database 134 and used by the carbon savings application 132 to determine carbon credits for the service point 20 during normal operation and during control events.

As well understood in the art, one carbon credit corresponds to the emission of one metric ton of carbon dioxide equivalents into the atmosphere. The term “carbon dioxide equivalents” is used because greenhouse gases include not only carbon dioxide, but also other gases such as methane, nitrous oxide, ozone, and chlorofluorocarbons. Each of these gases can be measured in terms of an equivalent amount of carbon dioxide or carbon dioxide equivalents.

According to one embodiment of the present invention, carbon credits may generally be calculated as the sum of carbon credits associated with the fuel or generation mix producing the power consumed and, optionally, carbon credits associated with the transmission line loss for propagating the generated power to the service point 20. The fuel mix carbon credits may be computed according to the following equation (Equation 1):

$$Fuel mix carbon credits = \frac{\begin{matrix}{{\sum }_{i = 0}}^{i = number of generating sources} carbon {footprint}_{i} * \\ energy savings * percent of {mix}_{i}\end{matrix}}{1000}$$

where
carbon footprintᵢ=the number of kilograms of carbon dioxide equivalents CO₂e emitted into the atmosphere per kilowatt hour of power generated (kgCO₂e/kWh) for fuel/energy source i;
energy savings is the number of kilowatt hours (kWh) that were not used during a specific time period (e.g., during a control event) based on the power consumption data received from the active load client 300; and

$$percent of {mix}_{i} = \frac{Total power generated by {source}_{i}}{Total power generated by all sources}$$

Examples of carbon footprints for various energy sources include:
Coal, 1.000 kgCO₂e/kWh
Oil, 0.650 kgCO₂e/kWh
Gas, 0.500 kgCO₂e/kWh
Biomass, 0.093 kgCO₂e/kWh
Solar, 0.058 kgCO₂e/kWh
Marine, 0.050 kgCO₂e/kWh
Hydro, 0.030 kgCO₂e/kWh
Wind, 0.005 kgCO₂e/kWh
Nuclear, 0.005 kgCO₂e/kWh

When power is generated or acquired by a utility, it is typically the result of a mixture of fuel or energy sources (i.e., a generation mix). For power generated by the utility, the utility knows which energy sources it has used to produce electricity during any period of time. For power acquired from other utilities through the Federal Energy Regulatory Commission (FERC) and the North American Electric Reliability Corporation (NERC), the utility may obtain the generation mix for the acquired power from FERC and/or NERC, as applicable. As noted above, each fuel or energy source has its own non-zero “carbon footprint” measured in kilograms of carbon dioxide equivalents per kilowatt hour. The carbon footprints for the fuel or energy sources are due to, for example, the emission of carbon dioxide and other greenhouse gases during the particular source's generation of electricity, during the production of components used by the particular source to generate electricity (e.g., photovoltaic cells for solar energy), and/or during the acquisition of fuel used by the particular source to generate electricity (e.g., mining of uranium for nuclear energy).

During control events, the ALD 100 captures and records the times when energy is not used, as well as how much energy was not used, based on the stored power consumption data for a particular service point 20. Using the power consumption information and information regarding the generation mix of power produced and/or acquired by the utility during the time period of a control event, the ALD 100 (e.g., through operation of the carbon savings application 132 as executed by a processor 160) multiplies the amount of energy savings (in kilowatt hours) resulting from the control event by the fraction or percent a particular fuel source constitutes the entire energy mix and the carbon footprint for that fuel source, and sums the calculated products for all fuel or energy sources forming the generation mix during the control event. As provided in Equation 1 above, the sum is divided by 1000 to yield the number of carbon credits because there are 1000 kilograms (kg) per metric ton and each carbon credit represents one metric ton of emissions.

In an alternative embodiment, the generation mix during a particular period of time may be determined or presumed to be a single type of fuel. For example, when a service point 20 is in close proximity to a specific generator (e.g., a coal fired power plant), all of the power supplied to that service point may be determined to come from the specific generator. Thus, the generation mix for that service point may be determined to be the fuel used at or by the closest generator.

When utilized, the carbon credits associated with transmission line loss take into account the resistive and reactive losses that normally occur during the transmission of power from a generating plant to a service point. The loss of power results from the conversion of electricity to heat or electromagnetic energy as alternating current is conducted along the transmission lines. Consequently, utilities must transmit additional power due to expected line losses in order to supply a desired amount of power at a service point. For example, if a service point requires 10 MWh of electricity for a particular time period and the power lost between the generating plant and the service point is 0.3 MWh due to line losses, the utility must actually supply 10.3 MWh of power to meet the service point needs. When power is not consumed at the service point (e.g., during a control event), the power savings includes the power not consumed at the service point, as well as the power that is not lost in the transmission lines. Thus, for increased accuracy, the calculation of carbon credits associated with a control event may, and should preferably, take into account the line loss power savings. Thus, the formula for line loss carbon credits for a service point may be calculated from the following equation (Equation 2):

$$line loss carbon credits = \frac{\begin{matrix}{\sum }_{i = 0}^{i = number of generating sources} carbon {footprint}_{i} * \\ line loss * percent of {mix}_{i}\end{matrix}}{1000}$$

$$where$$

$$line loss = \frac{total line loss for service area}{number of service points in service area}$$

total line loss for service area is the total amount of power (in Megawatts) dissipated during line loss,
number of service points in service area is the total number of service points within the utility's service area, and
percent of mixᵢ and carbon footprintᵢ are given by the formulas provided above with respect to Equation 1.
   The total line loss for a service area may be calculated using generally accepted models of line loss as provided by the United States Department of Energy.

Taking into account line loss, the total carbon credits used by a service point 20 during normal operation or saved by a service point 20 as a result of a control event is the sum of the fuel mix carbon credits and the line loss carbon credits. In other words, when line loss is taken into consideration, the total amount of carbon credits may be given by the following equation (Equation 3):

total carbon credits=fuel mix carbon credits+line loss carbon credits

Carbon credits may be calculated under various circumstances in accordance with the present invention. For example, carbon credits may be determined during or after the initiation or completion of one or more control events at a service point during a specific period of time (e.g., during the hours of 12:00 PM-5:00 PM on a Saturday during August). When multiple control events are involved, the total quantity of carbon credits is the sum of the carbon credits for all the control events.

Alternatively, carbon credits may be determined after the ALMS carries out a schedule or series of control events at a service point 20 based on an energy program created by the customer (e.g., to manage the customer's monthly electricity costs). The total quantity of carbon credits is the sum of the carbon credits for the entire series of control events.

Further, carbon credits may be determined due to a return of power to the power grid by a power storage device 62 at the service point 20 depending on the generation mixes of the utility at the times when power was obtained from a utility and stored by the power storage device 62 and when power was dispatched or returned to the power grid from the power storage device 62. For example, the power storage device 62 may store power during a different time period than when it dispatches power back to the power grid. Depending upon the timing of these storage and dispatch activities, the “generation mix” of power sources for the utility may have a lower carbon footprint when power is stored by the storage device 62 than when power is dispatched from the power storage device 62 back to the grid. In such a case, the quantity of carbon credits used during power storage may be less than the quantity of carbon credits earned during power dispatch due to the differences in generation mix during the respective storage and dispatch time periods. As a result, the service point 20 or the power storage device owner may earn net carbon credits as a result of the storage and dispatch procedures. The quantity of net carbon credits earned is the difference between the quantity of carbon credits consumed during power storage and the quantity of carbon credits earned during power dispatch.

Further, some activities at the service point 20 may result in cost savings, as well as lower the overall carbon footprint at the service point 20. For instance, power added to the utility's grid from a power generation device 96 at the service point 20 may earn carbon credits if the power generation device 96 emits non-carbon greenhouse gases (which can be converted to carbon dioxide equivalents as discussed above). When the level of carbon dioxide equivalents emitted by the power generation device 96 is less than the level of carbon dioxide and/or carbon dioxide equivalents emitted by the utility to supply an equivalent amount of power, the service point's carbon footprint experiences a net reduction due to use of the power generation device 96. As a result, carbon credits are earned because power generation from the utility was prevented by using a local power generating device 96.

As described above, the present invention encompasses a system and method for determining measurable, reportable, and verifiable carbon credits using a two-way measuring and reporting system (e.g., ALMS 10). Carbon credits as determined in accordance with the present invention are measurable because the ALD 100 stores energy consumption and related data at the device and service point levels in the ALD database 124 or another accessible repository. Energy consumption data is accurately measured by each active load client 300 and preferably sent to the ALD 100 periodically (e.g., every five minutes or at other intervals), but may be alternatively reported or requested (e.g., from the ALD 100 to the active load client 300) as often as necessary to achieve or maintain promulgated validation requirements, such as those provided under the Kyoto Protocol as proposed for implementation by the Bali Roadmap. The reporting frequency for automatic reporting may be a function of processor speed, memory capabilities, and transmission speed of transmissions between the active load client 300 and the ALD 100. As one of ordinary skill in the art will readily recognize and appreciate, power consumption and other data collected by an active load client 300 may be reported to the ALD 100 in batches, thereby allowing the active load client 300 to send very detailed measurement data to the ALD 100 without increasing the frequency of data transmissions. The measurement data supplied by each active load client 300 may be verified by the utility or a third party through querying of the ALD database 124 and/or querying of data optionally stored at the active load client 300. For example, the ALD database 124 can be queried by the power savings application 120 to retrieve the actual historical energy consumption data for the service point 20 or controlled devices thereat. The optional inclusion of specific location information based on geodetic references, such as GPS, topographical coordinates, physical address, and/or meter base number, further provides sufficient geodetic reference data to substantiate the credible and actual location of the power savings achieved, and resulting carbon credits earned, by the service point 20.

The acquisition, accumulation, and aggregation of information concerning the quantities of power saved and the generation mix of such power as provided by the ALMS 10 facilitates the accurate calculation of carbon footprint per location or service point 20. The additional input of weather information from both public (e.g., local, state, or national weather services) and private sources, as well as relevant land use information (e.g., urban, suburban, rural, forested, deforested, desert, etc.) may be used to even more accurately determine the levels of emissions curtailed due to execution of control events and the resulting carbon credits earned as a result thereof. For example, heavily wooded areas of a country or state may absorb carbon dioxide easier due to the prevalence of trees and vegetation. Weather also impacts the ability of the atmosphere to absorb carbon dioxide. For instance, ozone alerts are issued during periods of high humidity, low wind, and high temperatures.

Carbon credits determined in accordance with the present invention are also reportable because the ALD 100 may provide reports of the determined carbon credits using the customer reports application 118. For example, after determination of carbon credits by the carbon savings application 132 and storage thereof in the ALD database 124, the customer reports application 118 may be configured to detect the storage of carbon credit information or updated carbon credit information in the ALD database 124 and send a report containing the new or updated carbon credit information to a programmed target (e.g., the service point owner, the utility servicing the service point 20, a carbon credit trading exchange or broker, etc.). Communication of the carbon credits may be by any established or newly developed communication means, such as via email, via a proprietary communications protocol, or through encryption over a non-proprietary communications protocol.

Besides taking into account generation mix and line loss, the determination of carbon credits may take into account additional factors, such as device duty cycle, device start-up current, and transmission equipment k-factor. Duty cycle may affect the determination of carbon credits because carbon credits are calculated based on whether a device is not using power during a control event. Therefore, if a customer has overridden an initiated control event by, for example, submitting an override request through the customer dashboard 98, the device that would otherwise be turned off during the control event is not actually saving power. Because the ALD 100 has knowledge of the override, the ALD 100 can take the override into account when determining carbon credits. Additionally, duty cycle indicates the amount of time a device is normally on and off during a particular period of time. Therefore, if a control event occurs during a time period when the device's duty cycle is less than 100% or 1.0, then the quantity of carbon credits earned with respect to the device may be adjusted to account for the device's duty cycle during the control event. Still further, a duty cycle may be determined for a service point 20 as the percentage of time that all the controlled devices at the service point 20 are consuming power during a particular period of time. In such a case, the service point 20 may have multiple duty cycles (e.g., a different one for each quarter or other part of an hour). The carbon credit determination can take into account the duty cycle of the service point 20 during the time period of a control event (e.g., the carbon credits may be computed in accordance with Equation 3 and then multiplied by the service point duty cycle for the time period or time period segments of the control event).

Start-up current is the additional surge in current required by a device when the device is first powered up or turned on. Start-up current is normal with most devices. Existing procedures for determining carbon credits do not take start-up current into account. Instead, such procedures compute carbon credits based on steady state power consumption of a device. Use of two way reporting devices, such as the active load client 300, in accordance with the present invention allow the ALD 100 or other comparable control device to determine, through previously reported power consumption data, the amount of start-up and steady-state power saved as a result of a control event. Accordingly, the ALD 100 (e.g., through execution of its carbon savings application 132) can more accurately compute the carbon credits earned by a service point 20 as a result of a control event by taking into account the start-up power saved during the control event.

K-factor is a numerical rating given to electrical transmission equipment (e.g., transformers, switches, generators, high voltage transmission lines, step up/down transformers, fuses, circuit breakers, line switches, distribution transformers, distribution line losses, meters, end customer equipment, etc.) that relates to the equipment's ability to maintain and transmit electricity to service points 20 throughout a utility's service area. When equipment does not transmit all of the current sent to it, some current is lost, which contributes to line loss, as discussed above. To compensate for line loss, a utility must transmit additional power to the service point 20 such that, when line loss is taken into account, the service point 20 receives the power needed. By using the k-factor ratings of equipment used in transmission, the utility can more accurately estimate the additional power that must be generated to compensate for line loss. When a device or service point 20 participates in a control event, power savings resulting from the control event can also include power saved due to the avoidance of line loss. Thus, the ALD 100 can make use of k-factor data to more accurately determine line loss carbon credits as set forth above in Equation 2.

In another embodiment for improving the accuracy of determining carbon credits according to the present invention, the ALD database 124 may be updated by an active load client 300 to inform the ALD 100 when a device that is normally always in the “on” state (e.g., an environmentally-independent device) is explicitly turned off through instructions given by the customer separate from the settings maintained in the customer personal settings 138 (e.g., by using the customer dashboard 98 to instruct the device to shut off or by manually shutting the device off, such as by unplugging the device or switching off a circuit breaker for the device). The energy saved by turning the device off is reported to the ALD 100, stored in the utility power and carbon database 134, and used by the carbon savings application 132 to determine the carbon credits associated with the turn-off event based on Equation 3 above. The carbon savings application 132 may alternatively or additionally use the ALD database 124 to determine when a customer has manually adjusted a thermostat temperature set point or other device control set point from a previously-established “normal” set point. The energy saved as a result of the set point adjustment may be reported to the utility power and carbon database 134 and used by carbon savings application 132 to determine the carbon credits associated with the adjustment event based on Equation 3 above. Therefore, in addition to carbon credits earned as a result of ALD-initiated control events, carbon credits may be earned by power conservation actions taken unilaterally by the service point customer.

As generally discussed above with respect to the optional inclusion of a power generating device 96 at the service point 20, the ALMS 10 of the present invention supports net metering. For example, referring back to FIG. 1, a power generating device 96, such as solar panels, wind turbines, or fuel cells, may, under certain circumstances and/or during certain periods of time, create electricity and add the created electricity to the power grid. In one embodiment, the power generating device 96 communicates information regarding the quantity of power generated to the active load client 300 through the power dispatch device interface 340, as shown in FIG. 4. The power dispatch device interface 340 forwards the data regarding the amount of power generated and the time or time period during which power generation occurred to the device control manager 314, which relays the data to the ALD 100 via the IP-based communication converter 312, the security interface 310, the IP router 320, and the communications interface 308.

As also generally discussed above, the ALMS 10 of the present invention supports the inclusion or use of power storage devices, such as batteries or electric vehicles, at a service point 20. Referring again to FIG. 1, a power storage device 62 may be used to store and/or dispatch energy. When the power storage device 62 is located at a service point 20 and receives energy from the grid and/or from a local power generating device 96, the active load client 300 notifies the ALD 100. The ALD 100 logs the amount of energy supplied to and stored by the power storage device 62 and the time period of the storage activity in the ALD database 124. The ALD 100 also determines the carbon footprint and the carbon credits associated with the storage activity according to Equations 1, 2, and/or 3, as applicable, as detailed above. For example, to determine the carbon footprint and carbon credits associated with the power storage activity, the ALD 100 determines a generation mix relating to the amount of power supplied to the power storage device 62.

When the storage device 62 is used to send or dispatch energy into the power grid, the active load client 300 again notifies the ALD 100. The ALD 100 logs the amount of power dispatched and the time period of the dispatch activity in the ALD database 124. The ALD 100 also determines the carbon footprint and the carbon credits associated with the dispatch activity according to Equations 1, 2, and/or 3, as applicable, as detailed above. For example, to determine the carbon footprint and carbon credits associated with the power dispatch activity, the ALD 100 determines a generation mix relating to power supplied by the power grid to a service area containing the service point 20 at which the power storage device 62 was located during the dispatch activity. The ALD 100 then determines the net carbon credits earned, if any, resulting from the storage and dispatch activities by subtracting the carbon credits associated with the power storage activity from the carbon credits associated with the power dispatch activity, associates any earned credits with the service point 20 or the storage device owner, and stores the earned credits in the utility power and carbon database 134. Thus, if the storage device 62 is charged by a utility during the night when much of the energy supplied by the utility comes from a carbon free source, such as wind turbines, and is then discharged or dispatched during the day and at a peak time when much of the energy supplied by the utility is being generated from sources that emit carbon dioxide, such as coal and gas, the dispatch of energy may result in net carbon credits earned by the service point 20 or the storage device owner based on the results of Equation 3 for the two different time periods, generation mixes, and amounts of power stored and dispatched.

In one embodiment, the power stored in the power storage device 62 may be managed by the ALMS 10 (e.g., through the ALD 100). Such management may involve controlling when the power storage device 62 will draw or store power and using power stored in the power storage device 62 when needed by a utility. Controlling when the power storage device 62 will draw power may involve specifying the best times for the power storage device 62 to draw power from the grid so as to, for example, minimize the carbon footprint associated with such storage activity. Allowing the ALMS 10 to control when power stored by power storage devices 62 is used enables a utility to draw power from power storage devices 62 during times of critical need in order to avoid a brownout or blackout. If power is allowed to be drawn from the power storage device 62 in response to a request from a utility to the ALMS 10, an alert is sent to the customer. The customer may be provided a reward, monetary credit or other benefit to encourage participation in storage device management.

Management of power storage devices 62 by the ALMS 10 may be provided through the customer dashboard 98 (e.g., as an extension to the customer sign-up application 116, as a separate power storage device management application, as part of the customer's energy program, or otherwise). The customer dashboard 98 may inform the customer as to preferred times for the power storage device 62 to be plugged into or otherwise connected to the power grid for purposes of storing power in the power storage device 62 and preferred times for the power storage device 62 to be plugged into or connected to the power grid for purposes of dispatching power from the power storage device 62 to the power grid so as to, for example, maximize the customer's earned carbon credits.

In another embodiment, the power storage device 62 may be connected to the power grid at a service point other than its home or base service point. For example, an electric or hybrid electric car may be plugged in at a house being visited by the owner or user of the car. In such an example, the power storage device 62 (electric or hybrid electric car) may still be managed as described above. When the power storage device 62 is connected to the power grid and receives energy from the grid, the active load client 300 at the visited service point notifies the ALD 100 and provides an identifier (ID) of the power storage device 62. The ALD 100 logs the amount of power used and the time period of the storage activity in an entry of the ALD database 124 associated with the device ID. The ALD 100 also determines the carbon footprint and the carbon credits associated with the storage activity according to Equations 1, 2, and/or 3, as applicable, as detailed above. For example, to determine the carbon footprint and carbon credits associated with the power storage activity, the ALD 100 determines a generation mix relating to the amount of power supplied to the power storage device 62.

When the power storage device 62 is used to send or dispatch energy into the power grid, the active load client 300 at the service point at which the power storage device 62 is currently located notifies the ALD 100 with the device ID of the power storage device 62. The ALD 100 logs the amount of power dispatched and the time period of the dispatch activity in the ALD database 124. The ALD 100 also determines the carbon footprint and the carbon credits associated with the dispatch activity according to Equations 1, 2, and/or 3, as applicable, as detailed above. For example, to determine the carbon footprint and carbon credits associated with the power dispatch activity, the ALD 100 determines a generation mix relating to power supplied by the power grid to a service area containing the service point 20 at which the power storage device 62 was located during the dispatch activity. The ALD 100 then determines the net carbon credits earned, if any, resulting from the storage and dispatch activities by subtracting the carbon credits associated with the power storage activity from the carbon credits associated with the power dispatch activity, associates any earned credits with the power storage device's home or base service point 20 or the storage device's owner, and stores the earned credits in the utility power and carbon database 134.

As illustrated in FIG. 2, the data associated with the storage and dispatch activities of the power storage device 62 is received from the applicable active load client 300 through the ALC interface 112 and the security interface 110. The data is processed through the ALC manager 108 to the ALD database 124. The carbon savings application 124 uses the data to calculate power and carbon savings, which is stored in the utility power and carbon database 134. Power and carbon savings are accounted for in accordance with utility policy, governmental regulations, and customer preferences. For instance, such accounting may involve the determination of carbon credits, the determination of rebate or reward credits from the utility, power rate discounts, and other options.

To account for the mobility of power storage devices 62, the ALD database 124 optionally stores identifiers (IDs) for all controlled devices and storage devices associated with each service point 20. When reporting power consumed or dispatched by a power consuming device or power storage device 62, the active load client 300 includes the device ID, which is then mapped upon receipt by the ALD 100 based on the IDs stored in the ALD database 124. In this manner, the service point 20 for which the power storage device has been associated in the ALD database 124 receives credit for any net carbon credits earned as a result of the dispatch of power back to the grid from a power storage device 62 regardless of where within the utility's service area or elsewhere such dispatch occurs.

In accordance with another embodiment of the present invention, the ALMS 10 may be used to determine renewable energy credits (RECs). The determination of RECs is very similar to the determination of carbon credits, except that the fuel generation mix is not considered. For example, RECs may be determined using the following equation (Equation 4):

Renewable energy credits=(energy saved+line loss)/1000

where
energy saved is the amount of energy saved during control events in kilowatt hours;

$$line loss = \frac{total line loss for service area}{number of service points in service area} ;$$

total line loss for service area is the total number of kilowatt hours of power dissipated during line loss; and
number of service points in service area is the total number of service points within the utility's service area.

Therefore, in the same way that the determination of carbon credits is “measurable, reportable, and verifiable” as detailed above, the determination of renewable energy credits in accordance with the present invention is also “measurable, reportable, and verifiable.” All the information necessary for the ALD 100 or other processing device to determine RECs is acquired from active load clients 300, third parties (e.g., k-factors used in determination of line loss), and field measurements (e.g., total line loss for service area). A utility may offer to sell at least some of the renewable energy credits on an open market, under agreements with other electric utilities, or otherwise.

In the foregoing specification, the present invention has been described with reference to specific embodiments. However, one of ordinary skill in the art will appreciate that various modifications and changes may be made without departing from the spirit and scope of the present invention as set forth in the appended claims. For example, the ALD 100 may be replaced by any centralized or distributed processor or processing arrangement that is communicatively coupled to active load clients 300 or other two-way reporting devices distributed throughout the service area of a utility. Additionally, when implementing a energy conservation program for a customer, a control event or “Cut” message communicated from the ALD 100 to the active load client 300 may include program details or other control information (e.g., times and durations for control events, times for reporting amounts of saved energy, and so forth) sufficient to enable the active load client 300 to automatically execute the energy program at the service point 20 with little to no additional input from the ALD 100. Further, the functions of specific modules within the ALD 100, the active load client 300, and/or a virtual electric utility 1302 may be performed by one or more equivalent means. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

What is claimed is:

1. A method for determining carbon credits earned as a result of a control event in which power is reduced to at least one service point connected to a power grid serviced by at least one utility, the method comprising:
determining, during at least one period of time, power consumed by at least one device located at the at least one service point to produce power consumption data;
storing the power consumption data;
initiating a control event during which power is reduced to the at least one device;
determining an amount of power reduced during the control event based on the stored power consumption data;
determining a generation mix for power that would have been supplied to the at least one device during a time period of the control event if the control event had not occurred; and
determining a quantity of carbon credits earned based at least on the amount of power reduced and the generation mix.

2. The method of claim 1, wherein the generation mix includes a set of energy sources that have carbon footprints due to associated emissions of greenhouse gases in connection therewith and wherein determining a quantity of carbon credits earned comprises:
determining a quantity of carbon credits earned based at least on the power reduced, the generation mix, and the carbon footprints of the set of energy sources.

3. The method of claim 1, further comprising:
determining a line loss between a power generating plant of the at least one utility and the at least one service point; and
wherein determining a quantity of carbon credits earned includes:
determining a quantity of carbon credits earned based at least on the amount of power reduced, the generation mix, and the line loss.

4. The method of claim 3, wherein determining a line loss between a power generating plant of the at least one utility and the at least one service point comprises:
determining a line loss between the power generating plant and a service area of the utility in which the at least one service point is located.

5. The method of claim 3, wherein the power grid includes electrical transmission equipment and wherein determination of line loss takes into account k-factors of the electrical transmission equipment.

6. The method of claim 1, wherein the at least one service point includes a power storage device, the method further comprising:
determining an amount of power supplied to the power storage device during a first time period;
determining a first generation mix relating to the amount of supplied power;
determining an amount of power dispatched to the power grid from the power storage device during a second time period;
determining a second generation mix relating to power supplied by the power grid during the second time period to a service area in which the at least one service point is located; and
determining net carbon credits earned with respect to dispatch of power from the power storage device based on the amount of power supplied to the power storage device, the first generation mix, the second generation mix, and the amount of power dispatched to the power grid by the power storage device.

7. The method of claim 1, wherein initiating the control event comprises:
initiating the control event responsive a command from the at least one utility.

8. The method of claim 1, wherein initiating the control event comprises:
initiating the control event responsive to stored customer personal settings.

9. The method of claim 1, wherein the method is performed by a controller that is located remotely from the at least one service point.

10. The method of claim 1, wherein determining power consumed by the at least one device comprises:
receiving, from at least one client device located at the least one service point, power consumption information for the at least one device; and
determining power consumed by the at least one device based on the received power consumption information.

11. The method of claim 10, wherein initiating a control event comprises:
transmitting a message to the at least one client device, the message instructing the at least one client device to turn off power to the at least one device.

12. The method of claim 11, wherein the message includes control information sufficient to enable the at least one client device to implement an energy conservation program at the at least one service point.

13. The method of claim 11, further comprising:
receiving an override request to terminate the control event with respect to one or more devices of the at least one device;
responsive to the override request, transmitting a second message to the at least one client device, the second message instructing the at least one client device to turn on power to the one or more devices; and
determining the quantity of carbon credits taking into account early termination of the control event with respect to the one or more devices.

14. The method of claim 10, wherein the at least one device requires start-up current upon initial power up, wherein the power consumption information includes information regarding the start-up current, and wherein determining an amount of power reduced during the control event further comprises:
determining an amount of power reduced during the control event taking into account the start-up current saved during the control event.

15. The method of claim 1, wherein each device of the at least one device has a respective duty cycle and wherein determining a quantity of carbon credits comprises:
determining a quantity of carbon credits earned based at least on the amount of power reduced to each device, the respective duty cycle of each device, and the generation mix.

16. The method of claim 1, wherein each device of the at least one device has a respective duty cycle, wherein each service point of the at least one service point has a respective duty cycle determined as a percentage of time that all devices located at the service point are consuming power during a particular period of time, and wherein determining a quantity of carbon credits comprises:
determining a quantity of carbon credits earned based at least on the amount of power reduced to each device, the respective duty cycle of each service point, and the generation mix.

17. The method of claim 1, wherein each device of the at least one device has a respective duty cycle, wherein each service point of the at least one service point has multiple duty cycles determined as percentages of time that all devices located at the service point are consuming power during particular periods of time, and wherein determining a quantity of carbon credits comprises:
determining a quantity of carbon credits earned based at least on the amount of power reduced to each device, the multiple duty cycles of each service point, and the generation mix.

18. The method of claim 1, wherein the at least one service point includes at least one power generating device that generates electricity during one or more periods of time and supplies the generated electricity to the power grid, and further includes at least one client device that interfaces between the at least one power generating device and a controller, the method further comprising:
receiving, by the controller from the at least one client device, data regarding an amount of power generated by the at least one power generating device and at least one time period during which the amount of power was generated and supplied to the power grid;
wherein determining power consumed by the at least one device located at the at least one service point includes determining, by the controller, net power consumed by the at least one device as power consumed by the at least one device less power generated by the at least one power generating device.

19. The method of claim 1, further comprising:
receiving, by a controller that is located remotely from the at least one service point and from a first client device located at a first service point of the at least one service point, a first notification that a power storage device received power from the power grid, the first notification indicating an identifier for the power storage device, an amount of power supplied to the power storage device, and a first time period associated with the supply of power to the power storage device;
determining, by the controller, the amount of power supplied to the power storage device during the first time period based on the first notification;
determining, by the controller, a first generation mix relating to the amount of power supplied to the power storage device;
receiving, by the controller from a second client device located at a second service point connected to the power grid, a second notification that the power storage device dispatched power to the power grid, the second notification indicating the identifier for the power storage device, an amount of power dispatched to the power grid, and a second time period associated with the dispatch of power from the power storage device to the power grid;
determining, by the controller, the amount of power dispatched to the power grid from the power storage device during the second time period based on the second notification;
determining, by the controller, a second generation mix relating to power supplied by the power grid during the second time period to a service area in which the second service point is located;
determining, by the controller, net carbon credits earned with respect to dispatch of power from the power storage device based on the amount of power supplied to the power storage device, the first generation mix, the second generation mix, and the amount of power dispatched to the power grid by the power storage device; and
storing, by the controller, the net carbon credits earned in a database entry associated with an owner of the power storage device.

20. A method for a controller of a load management system to determine carbon credits earned related to storage and dispatch of power by a power storage device, the power storage device being located at a service point that is connected to a power grid serviced by at least one utility, the method comprising:
receiving, from a client device located at the service point, a first notification that the power storage device received power, the first notification indicating an amount of power supplied to the power storage device and a first time period associated therewith;
determining the amount of power supplied to the power storage device during the first time period based on the first notification;
determining a first generation mix relating to the amount of power supplied to the power storage device;
receiving, from the client device, a second notification that the power storage device dispatched power to the power grid, the second notification indicating an amount of power dispatched to the power grid and a second time period associated therewith;
determining the amount of power dispatched to the power grid from the power storage device during the second time period based on the second notification;
determining a second generation mix relating to power supplied by the power grid during the second time period to a service area in which the service point is located; and
determining net carbon credits earned with respect to dispatch of power from the power storage device based on the amount of power supplied to the power storage device, the first generation mix, the second generation mix, and the amount of power dispatched to the power grid.

21. The method of claim 20, wherein the controller manages when the power storage device receives power from the power grid and when the power storage device dispatches power to the power grid.

22. A method for a controller of a load management system to determine carbon credits earned related to storage and dispatch of power by a power storage device, the method comprising:
receiving, from a first client device located at a first service point connected to a power grid serviced by at least one utility, a first notification that the power storage device received power while located at the first service point, the first notification indicating an identifier for the power storage device, an amount of power supplied to the power storage device, and a first time period associated with the supply of power to the power storage device;
determining the amount of power supplied to the power storage device during the first time period based on the first notification;
determining a first generation mix relating to the amount of power supplied to the power storage device;
receiving, from a second client device located at a second service point connected to the power grid, a second notification that the power storage device dispatched power to the power grid, the second notification indicating the identifier for the power storage device, an amount of power dispatched to the power grid, and a second time period associated the dispatch of power from the power storage device to the power grid;
determining the amount of power dispatched to the power grid from the power storage device during the second time period based on the second notification;
determining a second generation mix relating to power supplied by the power grid during the second time period to a service area in which the second service point is located;
determining net carbon credits earned with respect to dispatch of power from the power storage device based on the amount of power supplied to the power storage device, the first generation mix, the second generation mix, and the amount of power dispatched to the power grid; and
storing the net carbon credits earned in a database entry associated with an owner of the power storage device.

23. A method for determining renewable energy credits earned as a result of a control event in which power is reduced to at least one service point connected to a power grid serviced by at least one utility, the method comprising:
determining, during at least one period of time, power consumed by at least one device located at the at least one service point to produce power consumption data;
storing the power consumption data;
initiating a control event during which power is reduced to the at least one device;
determining an amount of power reduced during the control event based on the stored power consumption data;
determining a line loss between a power generating plant of the at least one utility and the at least one service point, the power generating plant supplying power to the at least one service point; and
determining a quantity of renewable energy credits earned based at least on the amount of power reduced and the line loss.

24. The method of claim 23, wherein determining a line loss between a power generating plant of the at least one utility and the at least one service point comprises:
determining a line loss between the power generating plant and a service area of the utility in which the at least one service point is located.

25. The method of claim 23, wherein the power grid includes electrical transmission equipment and wherein determination of line loss takes into account k-factors of the electrical transmission equipment.

26. The method of claim 23, wherein the method is performed by a controller that is located remotely from the at least one service point.

27. An apparatus for controlling consumption of power produced by at least one utility that provides electrical service to at least one service point, each service point including at least one device that consumes power during operation thereof, the apparatus comprising:
a database; and
a processor operable to:
determine, during at least one period of time, power consumed by the at least one device to produce power consumption data;
store the power consumption data in the database;
initiate a control event during which power is reduced to the at least one device;
determine an amount of power reduced during the control event based on the stored power consumption data;
determine a generation mix for power that would have been supplied to the at least one device during a time period of the control event if the control event had not occurred; and
determine a quantity of carbon credits earned based at least on the amount of power reduced and the generation mix.

28. The apparatus of claim 27, wherein the generation mix includes a set of energy sources that have carbon footprints due to associated emissions of greenhouse gases in connection therewith and wherein the processor is operable to determine a quantity of carbon credits earned by:
determining a quantity of carbon credits earned based at least on the power reduced, the generation mix, and the carbon footprints of the set of energy sources.

29. The apparatus of claim 27, wherein the processor is further operable to determine a line loss between a power generating plant of the at least one utility and the at least one service point and wherein the processor is operable to determine a quantity of carbon credits earned by determining a quantity of carbon credits earned based at least on the amount of power reduced, the generation mix, and the line loss.

30. The apparatus of claim 29, wherein the processor is operable to determine a line loss between a power generating plant of the at least one utility and the at least one service point by:
determining a line loss between the power generating plant and a service area of the at least one utility in which the at least one service point is located.

31. The apparatus of claim 29, wherein the power grid includes electrical transmission equipment and wherein the processor is operable to take into account k-factors of the electrical transmission equipment when determining the line loss between the power generating plant and the at least one service point.

32. The apparatus of claim 27, wherein the at least one service point is connected to a power grid of the at least one utility and includes a power storage device, and wherein the processor is further operable to:
determine an amount of power supplied to the power storage device during a first time period;
determine a first generation mix relating to the amount of supplied power;
determine an amount of power dispatched to the power grid from the power storage device during a second time period;
determine a second generation mix relating to power supplied by the power grid during the second time period to a service area in which the at least one service point is located; and
determine net carbon credits earned with respect to dispatch of power from the power storage device based on the amount of power supplied to the power storage device, the first generation mix, the second generation mix, and the amount of power dispatched to the power grid.

33. The apparatus of claim 27, wherein the processor is operable to initiate the control event responsive to a command from the utility.

34. The apparatus of claim 27, wherein the database stores customer personal settings for at least one customer of the at least one utility and wherein the processor is operable to initiate the control event responsive to the stored customer personal settings.

35. The apparatus of claim 27, further comprising:
a client device interface operable to communicate control signals to client devices to initiate and terminate control events and to receive information from client devices from which power consumed by the at least one device may be determined;
wherein the processor is further operable to:
receive, from at least one client device located at the least one service point, power consumption information for the at least one device; and
determine power consumed by the at least one device based on the received power consumption information.

36. The apparatus of claim 35, wherein the processor is operable to initiate a control event by transmitting a message to the at least one client device via the client device interface, the message instructing the at least one client device to turn off power to the at least one device.

37. The apparatus of claim 36, further comprising:
an Internet-based interface for receiving requests from customers of the at least one utility;
wherein the processor is further operable to:
receive, via the Internet-based interface, an override request to terminate the control event with respect to one or more devices of the at least one device;
transmit a second message to the at least one client device via the client device interface, the second message instructing the at least one client device to turn on power to the one or more devices; and
determine the quantity of carbon credits taking into account early termination of the control event with respect to the one or more devices.

38. The apparatus of claim 35, wherein the at least one device requires start-up current upon initial power up, wherein the power consumption information includes information regarding the start-up current, and wherein the processor is operable to determine an amount of power reduced during the control event by:
determining an amount of power reduced during the control event taking into account the start-up current saved during the control event.

39. The apparatus of claim 27, wherein each device of the at least one device has a respective duty cycle and wherein the processor is operable to determine a quantity of carbon credits by:
determining a quantity of carbon credits earned based at least on the amount of power reduced to each device, the respective duty cycle of each device, and the generation mix.

40. The apparatus of claim 27, wherein each device of the at least one device has a respective duty cycle, wherein each service point of the at least one service point has a respective duty cycle determined as a percentage of time that all devices located at the service point are consuming power during a particular period of time, and wherein the processor is operable to determine a quantity of carbon credits by:
determining a quantity of carbon credits earned based at least on the amount of power reduced to each device, the respective duty cycle of each service point, and the generation mix.

41. The apparatus of claim 27, wherein each device of the at least one device has a respective duty cycle, wherein each service point of the at least one service point has multiple duty cycles determined as percentages of time that all devices located at the service point are consuming power during particular periods of time, and wherein the processor is operable to determine a quantity of carbon credits by:
determining a quantity of carbon credits earned based at least on the amount of power reduced to each device, the multiple duty cycles of each service point, and the generation mix.

42. The apparatus of claim 27, wherein the at least one service point includes at least one power generating device that generates electricity during one or more periods of time and supplies the generated electricity to a power grid of the at least one utility, and at least one client device that interfaces to the at least one power generating device, the apparatus further comprising:
a client device interface operable to at least receive information from the at least one client device;
wherein the processor is further operable to:
receive, from the at least one client device via the client device interface, data regarding an amount of power generated by the at least one power generating device and at least one time period during which the amount of power was generated and supplied to the power grid; and
determine net power consumed by the at least one device as power consumed by the at least one device less power generated by the at least one power generating device.

43. The apparatus of claim 27, wherein the at least one service point includes a first service point and a second service point connected to a power grid of at least one utility, wherein the first service point includes a first client device, and wherein the second service point includes a second client device, the apparatus further comprising:
a client device interface operable to at least receive information from the first client device and the second client device;
wherein the processor is further operable to:
receive, from the first client device via the client device interface, a first notification that a power storage device received power while located at the first service point, the first notification indicating an identifier for the power storage device, an amount of power supplied to the power storage device, and a first time period associated with the supply of power to the power storage device;
determine the amount of power supplied to the power storage device during the first time period based on the first notification;
determine a first generation mix relating to the amount of power supplied to the power storage device;
receive, from the second client device via the client device interface, a second notification that the power storage device dispatched power to the power grid, the second notification indicating the identifier for the power storage device, an amount of power dispatched to the power grid, and a second time period associated with the dispatch of power from the power storage device to the power grid;
determine the amount of power dispatched to the power grid from the power storage device during the second time period based on the second notification;
determine a second generation mix relating to power supplied by the power grid during the second time period to a service area in which the second service point is located;
determine net carbon credits earned with respect to dispatch of power from the power storage device based on the amount of power supplied to the power storage device, the first generation mix, the second generation mix, and the amount of power dispatched to the power grid by the power storage device; and
store the net carbon credits earned in a database entry associated with an owner of the power storage device.

44. An apparatus for controlling consumption of power produced by at least one utility that provides electrical service to at least one service point, each service point including at least one device that consumes power during operation thereof, the apparatus comprising:
a database; and
a processor operable to:
determine, during at least one period of time, power consumed by the at least one device to produce power consumption data;
store the power consumption data in the database;
initiate a control event during which power is reduced to the at least one device;
determine an amount of power reduced during the control event based on the stored power consumption data;
determine a line loss between a power generating plant of the at least one utility and the at least one service point, the power generating plant supplying power to the at least one service point; and
determine a quantity of renewable energy credits earned based at least on the amount of power reduced and the line loss.

45. A system for controlling consumption of power produced by at least one utility that provides electrical service to at least one service point, each service point including at least one device that consumes power during operation thereof, the system comprising:
an active load client device operably coupled to the at least one device, the active load client device including:
a communications interface operable to communicate information from which power consumed by the at least one device may be determined and to receive control signals relating to a control event in which power is to be reduced to the at least one device;
a device control manager operably coupled to the communications interface, the device control manager being operable to control a flow of power to the at least one device responsive to the control signals and to acquire from at least one load controller associated with the at least one device the information from which power consumed by the at least one device may be determined;
an active load director located remotely from the active load client device, the active load director including:
an active load client device interface operable to communicate the control signals to the active load client device and to receive the information from which power consumed by the at least one device may be determined;
a database; and
a processor operable to:
determine power consumed by the at least one device based on the received information to produce power consumption data;
store the power consumption data in the database;
generate a control signal relating to a control event during which power is to be reduced to the at least one device;
determine an amount of power reduced during the control event based on the stored power consumption data;
determine a generation mix for power that would have been supplied to the at least one device during a time period of the control event if the control event had not occurred; and
determine a quantity of carbon credits earned based at least on the amount of power reduced and the generation mix.

46. The system of claim 45, further comprising the at least one load controller.
